(19) United States
(12) Patent Application Publication
(10) Pub. No.: US 2012/0287092 A1
(43) Pub. Date: Nov. 15, 2012

(54) DISPLAY DEVICE AND ELECTRONIC APPARATUS

(75) Inventors: Satoshi Tatara, Kanagawa (JP); Keisuke Omoto, Kanagawa (JP); Katsuhide Uchino, Kanagawa (JP)

(73) Assignee: SONY CORPORATION, Tokyo (JP)

(21) Appl. No.: 13/454,733

(22) Filed: Apr. 24, 2012

(30) Foreign Application Priority Data
May 10, 2011 (JP) 2011-105286

(51) Int. Cl. G06F 3/038

(52) U.S. Cl. 345/204

(57) ABSTRACT

A display device includes a control line through which a drive signal output from a driver is transmitted and transistors arranged along a direction in which the control line extends and driven with the drive signal transmitted through the control line. Parasitic capacitances between gates and sources/drains of the transistors are varied in accordance with distances thereof from the driver in the direction in which the control line extends.

### CROSS REFERENCES TO RELATED APPLICATIONS

The present application claims priority to Japanese Priority Patent Application JP 2011-105286 filed in the Japan Patent Office on May 10, 2011, the entire content of which is hereby incorporated by reference.

### BACKGROUND

The present disclosure relates to display devices and electronic apparatuses. In particular, the present disclosure relates to a flat-panel (a flat) display device in which pixels including electro-optical elements are arranged in a matrix and to an electronic apparatus having the display device.

As flat-panel display devices, organic EL (electroluminescent) display devices, LCD (liquid crystal display) devices, PDP (plasma display panel) devices, and so on are widely available.

In such a display device, pixels including electro-optical elements are arranged in a matrix on a substrate (panel) and drive signals for driving the pixels and so on are supplied from a driver, disposed at one side of the panel, or drivers, disposed at two opposite sides, through control lines. The control lines are wired along the direction in which the pixels in the pixel rows are arranged (i.e., in the row direction).

For flat-panel display devices, as the panel size increases, the wiring length of the control lines increases and thus the wiring resistance and the wiring capacitance increase. Because of an influence of the wiring resistance and the wiring capacitance, the waveform of the drive signal transmitted through the control line differs depending on the distance from the driver(s) in the direction in which the control line extends.

More specifically, since the influence of the wiring resistance and the wiring capacitance at a portion far from the driver(s) is larger than the influence thereof at a portion close to the driver(s), the waveform of the drive signal at the portion far from the driver(s) is rounded by a larger amount. Consequently, a difference occurs in the transistor driving with the drive signal occurs between the portion far from the driver(s) and the portion close to the driver. In order to address the problem, a basic-wave signal, such as a sine-wave signal, trapezoidal-wave signal, or a signal with a round rectangular waveform has been used (see, for example, Japanese Unexamined Patent Application Publication No. 2008-96554).

### SUMMARY

In the related art disclosed in Japanese Unexamined Patent Application Publication No. 2008-96554, since a basic-wave signal is merely used as a drive signal, it is difficult to achieve constant driving of the transistors with the drive signal regardless of the positions of the transistors in the direction in which the control line extends. Thus, it is desired that constant driving of transistors with a drive signal be achieved regardless of the positions of the transistors in the direction in which the control line lines, in other words, regardless of the wiring distances on the control line from the driver.

Accordingly, it is desirable to provide a display device that is capable of achieving constant driving of transistors with a drive signal output from a driver, regardless of the positions of the transistors in the direction in which a control line extends, and an electronic apparatus having the display device.

Accordingly, according to an embodiment of the present disclosure, there is provided a display device including: a control line through which a drive signal output from a driver is transmitted; and transistors arranged along a direction in which the control line extends and driven with the drive signal transmitted through the control line. Parasitic capacitances between gates and sources/drains of the transistors are varied in accordance with distances thereof from the driver in the direction in which the control line extends. This display device may be used as display devices in various electronic apparatuses.

Each of the transistors has a parasitic capacitance between the gate and the source/drain. During transition of the drive signal supplied to the gate electrode through the control line transitions, the capacitive coupling due to the parasitic capacitance at the transition timing causes the source/drain voltage to vary. The amount of coupling at this point depends on the transition waveform of the drive signal supplied to the gate electrode and the parasitic capacitance between the gate and the source/drain.

That is, when the transition waveform of the drive signal is steep, the amount of coupling is large, and when the transition waveform is gentle (i.e., is rounded), the amount of coupling is small. When the parasitic capacitance between the gate and the source/drain is large, the amount of coupling is large, and when the parasitic capacitance is small, the amount of coupling is small. Since the control line has a wiring resistance and a wiring capacitance, the waveforms of the drive signals differ depending on the distances from the driver in the direction in which the control line extends. Thus, varying the parasitic capacitances between the gates and the sources/drains of the transistors in accordance with the distances from the driver makes it possible to substantially equalize the amounts of coupling, regardless of the distances from the driver in the direction in which the control line extends.

According to the present disclosure, since the amounts of coupling can be substantially equalized regardless of the distances from the driver in the direction in which the control line extends, constant driving of the transistors with the drive signal output from the driver can be achieved regardless of the positions of the transistors in the direction in which the control line extends.

Additional features and advantages are described herein, and will be apparent from the following Detailed Description and the figures.

### BRIEF DESCRIPTION OF THE FIGURES

FIG. 1 is a system block diagram illustrating an overview of a basic configuration of an active matrix organic EL display device to which an embodiment of the present disclosure is applied;

FIG. 2 is a circuit diagram illustrating one example of a specific circuit configuration of one pixel (pixel circuit);

FIG. 3 is a timing waveform diagram illustrating a basic circuit operation of the organic EL display device to which the embodiment of the present disclosure is applied;

FIGS. 4A to 4D are diagrams (part 1) illustrating the basic circuit operation of the organic EL display device to which the embodiment of the present disclosure is applied;

FIGS. 5A to 5D are diagrams (part 2) illustrating the basic circuit operation of the organic EL display device to which the embodiment of the present disclosure is applied;

FIG. 6A is a graph illustrating a problem due to variations in a threshold voltage of a drive transistor and FIG. 6B is a graph illustrating a problem due to variations in mobility of the drive transistor;

FIG. 7 is a circuit diagram illustrating one example of the configuration of a signal output circuit employing a selector driving system;

FIG. 8 is a circuit diagram illustrating an example of a signal output circuit employing the selector driving system using transistors as switch elements;

FIG. 9 illustrates that gate input waveforms of selection transistors differ depending on the distance from drivers;

FIG. 10 illustrates display-image luminance-non-uniformity caused by the amount of coupling that differs depending on the distance from the drivers;

FIG. 11 illustrates a first embodiment in which the present disclosure is applied to the selection transistors in the selector-driving-system signal output circuit;

FIGS. 12A to 12C are schematic diagrams illustrating capacitive coupling;

FIGS. 13A and 13B illustrate relationships between the wiring resistance and wiring capacitance of a control line and a gate input waveform of the selection transistor;

FIG. 14 is a graph illustrating a simulation result with respect to the gate voltage of the selection transistor;

FIG. 15 is a graph illustrating a simulation result with respect to the source voltage of the selection transistor;

FIG. 16 is a graph illustrating the transient response of the gate waveform of the selection transistor versus the source voltage of the selection transistor;

FIG. 17 is a graph illustrating the transient response of the gate waveform of the selection transistor versus the parasitic capacitance between the gate and the source of the selection transistor;

FIG. 18 is a graph illustrating the wiring distance from the driver versus a gate-source overlap area;

FIG. 19 illustrates a failure caused by capacitive coupling due to the parasitic capacitance of a write transistor;

FIG. 20 is a timing waveform diagram illustrating a change in the gate potential of a drive transistor, the change being caused by the capacitive coupling;

FIG. 21 illustrates a second embodiment in which the present disclosure is applied to write transistors in pixels;

FIG. 22 is a perspective view illustrating the external appearance of a television set to which the embodiment of the present disclosure is applied;

FIGS. 23A and 23B are a front perspective view and a rear perspective view, respectively, illustrating the external appearance of a digital camera to which the embodiment of the present disclosure is applied;

FIG. 24 is a perspective view illustrating the external appearance of a notebook personal computer to which the embodiment of the present disclosure is applied;

FIG. 25 is a perspective view illustrating the external appearance of a video camera to which the embodiment of the present disclosure is applied; and

FIGS. 26A to 26G are external views of a mobile phone to which the embodiment of the present disclosure is applied, FIG. 26A being a front view of the mobile phone when it is opened, FIG. 26B being a side view thereof, FIG. 26C being a front view when the mobile phone is closed, FIG. 26D being a left side view, FIG. 26E being a right side view, FIG. 26F being a top view, and FIG. 26G being a bottom view.

### DETAILED DESCRIPTION

Modes (hereinafter referred to as “embodiments”) for realizing the technology according to the present disclosure will be described below in detail with reference to the accompanying drawings. A description below is given in the following sequence:

1. Organic EL Display Device to which Embodiment of Present Disclosure is Applied
1-1. System Configuration
1-2. Basic Circuit Operation
1-3. Selector Driving System
1-4. Failure Caused by Wiring Resistance and Wiring Capacitance of Control Line

2. Embodiments
2-1. First Embodiment (Example of Selection Transistors)
2-2. Second Embodiment (Example of Write Transistors)

3. Application Examples

4. Electronic Apparatuses

5. Configuration of Present Disclosure

### 1. Organic EL Display Device to which Embodiment of Present Disclosure is Applied

### 1-1. System Configuration

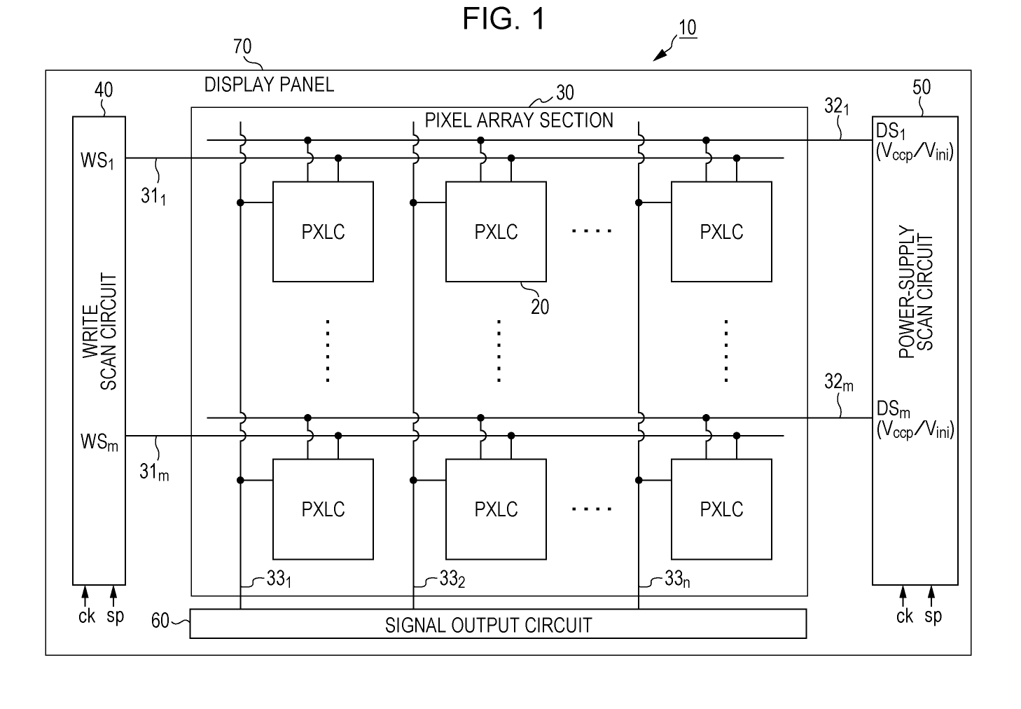

FIG. 1 is a system block diagram illustrating an overview of a basic configuration of an active matrix display device to which an embodiment of the present disclosure is applied.

In the active matrix organic display device, active elements (e.g., insulated-gate field effect transistors) provided in the same pixels as the pixels in which the electro-optical elements are provided control current flowing in the organic EL elements. The insulated-gate field effect transistors are typically implemented by TFTs (thin film transistors).

A description will be given of an example of an active matrix organic EL display device in which a current-driven electro-optical element (e.g., an organic EL element) having a light-emission luminance that varies according to the value of current flowing through the device is used as a light-emitting element of a pixel (a pixel circuit).

As illustrated in FIG. 1, an organic EL display device 10 according to the present application example has pixels 20 including organic EL elements, a pixel array section 30 in which the pixels 20 are two-dimensionally arranged in a matrix, and a drive circuit section disposed in the vicinity of the pixel array section 30. The drive circuit section includes a write scan circuit 40, a power-supply scan circuit 50, a signal output circuit 60, and so on to drive the pixels 20 in the pixel array section 30.

When the organic EL display device 10 is a color display device, a single pixel (a unit pixel) that serves as a unit for forming a color image is constituted by multiple sub pixels, which correspond to the pixel 20 illustrated in FIG. 1. More specifically, in the color display device, one pixel is constituted by three sub pixels, for example, a sub pixel for emitting red (R) light, a sub pixel for emitting green (G) light, and a sub pixel for emitting blue (B) light.

One pixel, however, is not limited to a combination of sub pixels having the three primary colors including RGB. That is, a sub pixel for another color or sub pixels for other colors may be further added to the three-primary-color sub pixels to constitute a single pixel. More specifically, for example, in order to improve the luminance, a sub pixel for emitting white (W) light may be added to constitute a single pixel or, in order to increase the color reproduction range, at least one sub pixel for emitting complementary color may be added to constitute a single pixel.

With respect to the pixels 20 arranged in m rows×n columns in the pixel array section 30, scan lines 31 (31₁ to 31ₘ) and power-supply lines 32 (32₁ to 32ₘ) are wired in corresponding pixel rows along a row direction (i.e., in a direction in which the pixels 20 in the pixel rows are arranged). In addition, with respect to the pixels 20 arranged in m rows×n columns, signal lines 33 (33₁ to 33ₙ) are wired in corresponding pixel columns along a column direction (i.e., in a direction in which the pixels 20 in the pixel columns are arranged).

The scan lines 31₁ to 31ₘ are connected to corresponding row output ends of the write scan circuit 40. The power-supply lines 32₁ to 32ₘ are connected to corresponding row output ends of the power-supply scan circuit 50. The signal lines 33₁ to 33ₙ are connected to corresponding column output ends of the signal output circuit 60.

In general, the pixel array section 30 is provided on a transparent insulating substrate, such as a glass substrate. Thus, the organic EL display device 10 has a flat panel structure. Drive circuits for the pixels 20 in the pixel array section 30 may be fabricated using amorphous silicon TFTs or low-temperature polysilicon TFTs. When low-temperature polysilicon TFTs are used, the write scan circuit 40, the power-supply scan circuit 50, and the signal output circuit 60 may also be disposed on the display panel (plate) 70 included in the pixel array section 30, as illustrated in FIG. 1.

The write scan circuit 40 includes shift register circuits or the like that sequentially shift (transfer) a start pulse sp in synchronization with a clock pulse ck. During signal-voltage writing of a video signal to the pixels 20 in the pixel array section 30, the write scan circuit 40 sequentially supplies write scan signals WS (WS₁ to WSₘ) to the corresponding scan lines 31 (31₁ to 31ₘ) to thereby sequentially scan the pixels 20 in the pixel array section 30 row by row (i.e., line sequence scanning).

The power-supply scan circuit 50 includes shift register circuits or the like that sequentially shift a start pulse sp in synchronization with a clock pulse ck. In synchronization with line sequential scanning performed by the write scan circuit 40, the power-supply scan circuit 50 supplies power-supply potentials DS (DS₁ to DSₘ) to the corresponding power-supply lines 32 (32₁ to 32ₘ). Each power-supply potential DS can be switched between a first power-supply potential V_{ccp} and a second power-supply potential Vᵢₙᵢ, which is lower than the first power-supply potential V_{ccp}. Through the switching between the power supply potentials V_{ccp} and Vᵢₙᵢ of the power-supply potential DS, light emission and light non-emission of the pixels 20 are controlled.

The signal output circuit 60 selectively outputs a signal voltage V_{sig} of a video signal corresponding to luminance information supplied from a signal supply source (not illustrated) and a reference voltage V_{ofs}. The reference voltage V_{ofs} serves as a reference potential for the signal voltage V_{sig} of the video signal (and corresponds to, for example, a voltage for a black level of a video signal) and is used for threshold correction processing (described below).

The signal voltage V_{sig} and the reference potential V_{ofs} selectively output from the signal output circuit 60 are written, for each pixel row selected by the scanning of the write scan circuit 40, to the corresponding pixels 20 in the pixel array section 30 through the signal lines 33 (33₁ to 33ₙ). That is, the signal output circuit 60 has a line-sequential writing drive system for writing the signal voltage V_{sig} row by row (or line by line).

### (Pixel Circuit)

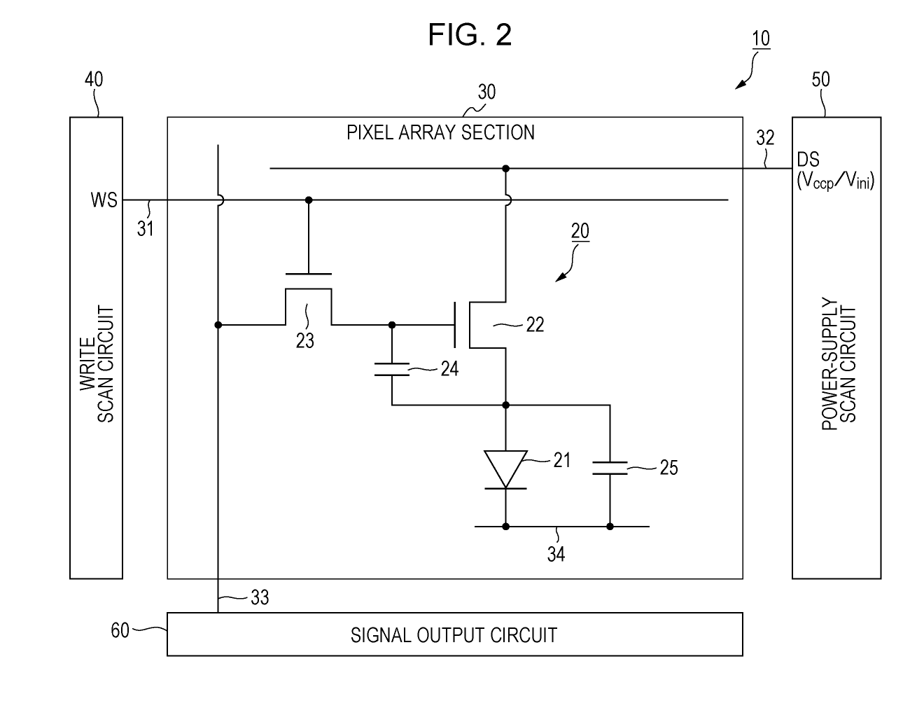

FIG. 2 is a circuit diagram illustrating one example of a specific circuit configuration of one pixel (pixel circuit) 20. The pixel 20 has a light emitting section including an organic EL element 21, which is a current-driven electro-optical element. The organic EL element 21 has a light-emission luminance that changes in accordance with the value of current flowing through the device.

As illustrated in FIG. 2, in addition to the organic EL element 21, the pixel 20 includes a drive circuit for driving the organic EL element 21 by flowing current to the organic EL element 21. The organic EL element 21 has a cathode electrode connected to a common power-supply line 34 that is wired with all pixels 20 (this wiring may be referred to as “common wiring”).

The drive circuit for driving the organic EL element 21 has a drive transistor 22, a write transistor 23, a storage capacitor 24, and an auxiliary capacitor 25. The drive transistor 22 and the write transistor 23 may be implemented by n-channel TFTs. However, the illustrated combination of conductivity types of the drive transistor 22 and the write transistor 23 is merely one example, and the combination of conductivity types is not limed thereto. In addition, the relationship of wiring connections of the transistors, the storage capacitor, the organic EL device, and so on is not limited to the disclosed relationship.

A first electrode (a source/drain electrode) of the drive transistor 22 is connected to an anode electrode of the organic EL element 21 and a second electrode (a source/drain electrode) of the drive transistor 22 is connected to a corresponding one of the power-supply lines 32 (32₁ to 32ₘ).

A first electrode (a source/drain electrode) of the write transistor 23 is connected to a corresponding one of the signal lines 33 (33₁ to 33ₙ) and a second electrode (a source/drain electrode) of the write transistor 23 is connected to a gate electrode of the drive transistor 22. A gate electrode of the write transistor 23 is connected to a corresponding one of the scan lines 31 (31₁ to 31ₘ).

The expression “first electrodes” of the drive transistor 22 and the write transistor 23 refer to metal wirings electrically connected to the source/drain regions and the expression “second electrodes” refer to metal wirings electrically connected to the drain/source regions. Depending upon a potential relationship between the first electrode and the second electrode, the first electrode acts as a source electrode or a drain electrode or the second electrode also acts as a drain electrode or a source electrode.

A first electrode of the storage capacitor 24 is connected to the gate electrode of the drive transistor 22 and a second electrode of the storage capacitor 24 is connected to the first electrode of the drive transistor 22 and the anode electrode of the organic EL element 21.

A first electrode of the auxiliary capacitor 25 is connected to the anode electrode of the organic EL element 21 and a second electrode of the auxiliary capacitor 25 is connected to the common power-supply line 34. The auxiliary capacitor 25 may be provided, as appropriate, in order to compensate for a shortage of the capacitance for the organic EL element 21 and in order to increase the write gain of the video signal with respect to the storage capacitor 24. That is, the auxiliary capacitor 25 is an arbitrary element, and may be eliminated when the equivalent capacitance of the organic EL element 21 is sufficiently large.

In this case, although the second electrode of the auxiliary capacitor 25 is connected to the common power-supply line 34, the second electrode of the auxiliary capacitor 25 may be connected to a node at a fixed potential, instead of the common power-supply line 34. Connection of the second electrode of the auxiliary capacitor 25 to a node at a fixed potential makes it possible to compensate for a shortage of the capacitance for the organic EL element 21 and also makes it possible to achieve an increase in the write gain of the video signal with respect to the storage capacitor 24.

The write transistor 23 in the pixel 20 having the above-described configuration enters a conductive state in response to a high (i.e., active) write scan signal WS supplied from the write scan circuit 40 to the gate electrode of the write transistor 23 through the scan line 31. The write transistor 23 then samples the signal voltage V_{sig} of the video signal (corresponding to the luminance information) or the reference potential V_{ofs} supplied from the signal output circuit 60 through the signal line 33 and writes the sampled signal voltage V_{sig} or the reference voltage V_{ofs} to the pixel 20. The written signal voltage V_{sig} or reference voltage V_{ofs} is applied to the gate electrode of the drive transistor 22 and is also stored by the storage capacitor 24.

When the power-supply potential DS of the corresponding one of the power-supply lines 32 (32₁ to 32ₘ) is the first power-supply potential V_{ccp}, the drive transistor 22 operates in a saturation region with its first electrode acting as a drain electrode and its second electrode acting as a source electrode. Thus, in response to the current supplied from the power-supply line 32, the drive transistor 22 drives the light emission of the organic EL element 21 by supplying drive current thereto. More specifically, by operating in the saturation region, the drive transistor 22 supplies, to the organic EL element 21, drive current having a current value corresponding to the voltage value of the signal voltage V_{sig} stored by the storage capacitor 24. The drive current causes the organic EL element 21 to be driven to emit light.

When the power-supply potential DS is switched from the first power-supply potential V_{ccp} to the second power-supply potential Vᵢₙᵢ, the drive transistor 22 operates as a switching transistor with its first electrode acting as a source electrode and its second electrode acting as a drain electrode. Through the switching operation, the drive transistor 22 stops the supply of the drive current to the organic EL element 21 to put the organic EL element 21 into a light non-emission state. That is, the drive transistor 22 also has the function of a transistor for controlling the light emission and non-emission of the organic EL element 21.

The drive transistor 22 performs a switching operation to provide a period (a light non-emission period) in which the organic EL element 21 does not emit light, thus making it possible to control the (duty) ratio of the light emission period and the light non-emission period of the organic EL element 21. Through the duty control, afterimage involved in the light emission of the pixel 20 throughout one display frame period can be reduced. Thus, in particular, the image quality of a moving image can be further improved.

Of the first and second power-supply voltages V_{ccp} and Vᵢₙᵢ selectively supplied from the power-supply scan circuit 50 through the power-supply line 32, the first power-supply potential V_{ccp} is a power-supply potential for supplying, to the drive transistor 22, drive current for driving the light emission of the organic EL element 21. The second power-supply potential Vᵢₙᵢ is a power-supply potential for reversely biasing the organic EL element 21. The second power-supply potential Vᵢₙᵢ is set lower than the reference voltage V_{ofs}. For example, the second power-supply potential Vᵢₙᵢ is set to a potential that is lower than V_{ofs}−Vₜₕ, preferably, to a potential that is sufficiently lower than V_{ofs}−Vₜₕ, where Vₜₕ indicates a threshold voltage of the drive transistor 22.

### 1-2. Basic Circuit Operation

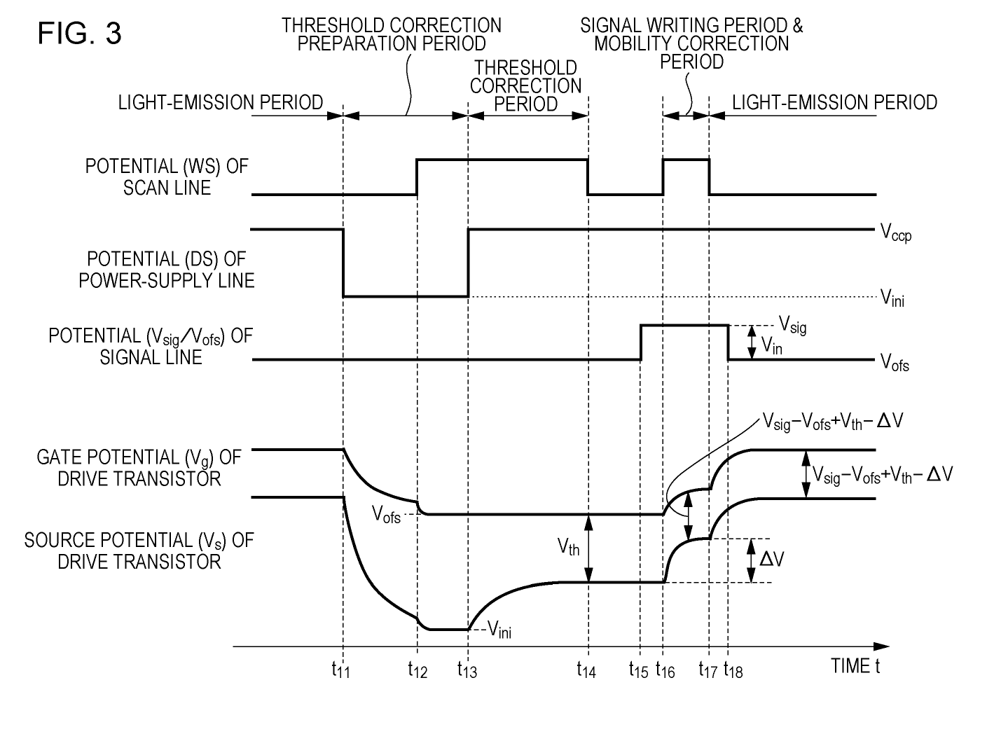

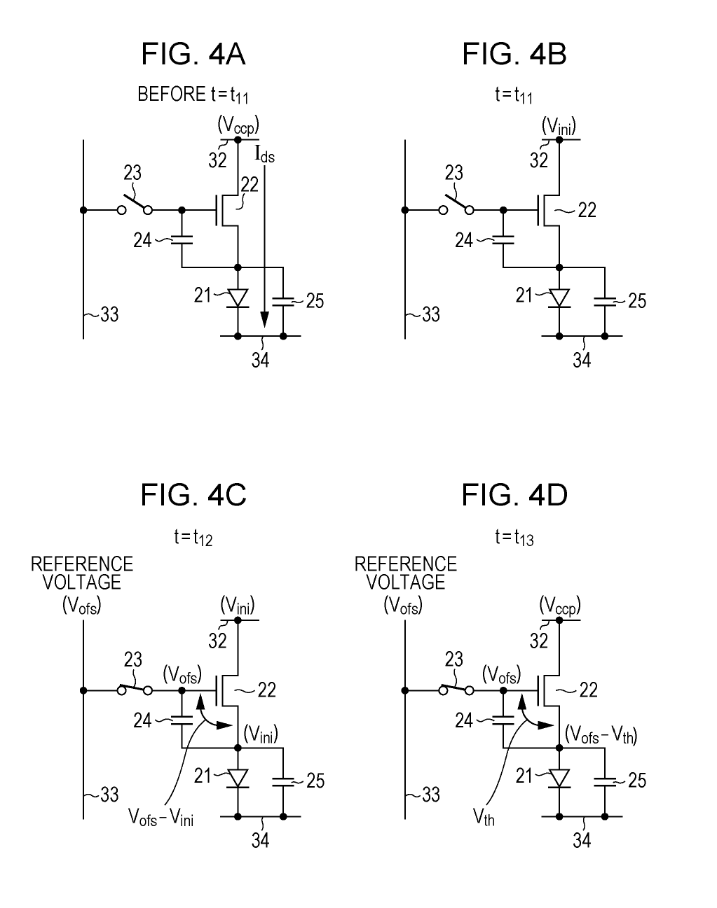

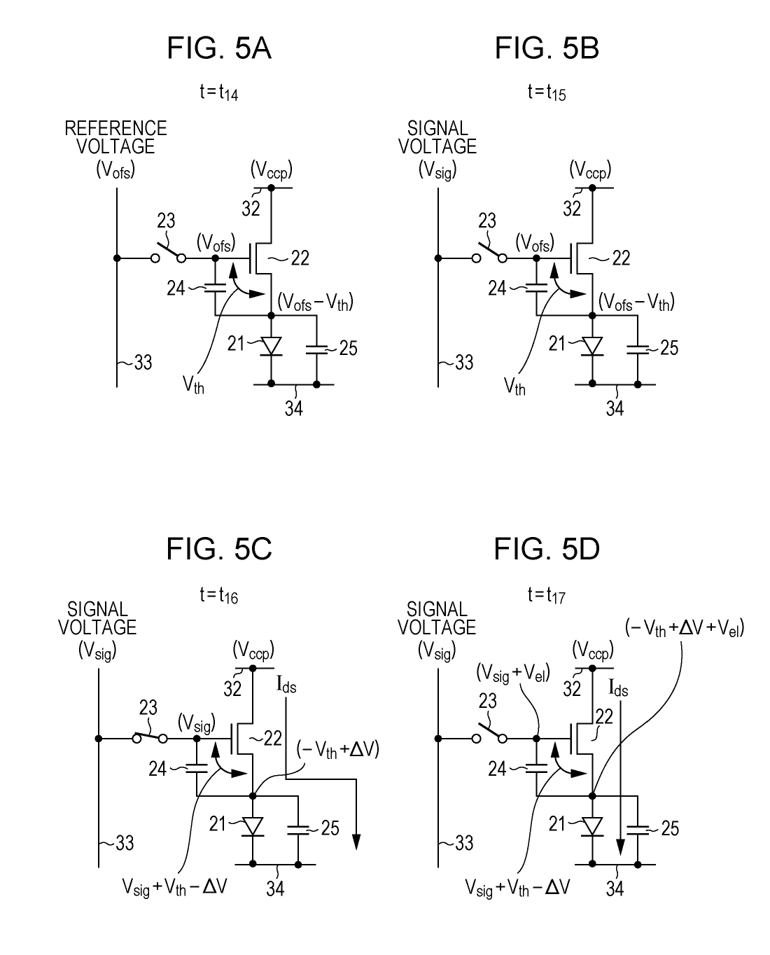

Next, a basic circuit operation of the organic EL display device 10 having the above-described configuration will be described with reference to a timing waveform diagram illustrated in FIG. 3 and operation diagrams illustrated in FIGS. 4A to 5D. In the operation diagrams illustrated in FIGS. 4A to 5D, the write transistor 23 is represented by a switch symbol, for simplicity of illustration.

The timing waveform diagram of FIG. 3 illustrates a change in the potential (write scan signal) WS of the scan line 31, a change in the potential (power-supply potential) DS of the power-supply line 32, a change in the potential (V_{sig}/V_{ofs}) of the signal line 33, and changes in a gate potential V_{g} and a source potential Vₛ of the drive transistor 22.

### (Light Emission Period of Previous Display Frame)

In the timing waveform diagram of FIG. 3, a period before time t₁₁ is a light emission period of the organic EL element 21 for a previous display frame. In the light emission period for the previous display frame, the potential DS of the power-supply line 32 is at the first power-supply potential (hereinafter referred to as a “high potential”) V_{ccp} and the write transistor 23 is in the non-conductive state.

The drive transistor 22 is designed so that, at this point, it operates in its saturation region. Thus, as illustrated in FIG. 4A, a drive current (a drain-source current) I_{ds} corresponding to a gate-source voltage V_{gs} of the drive transistor 22 is supplied from the power-supply line 32 to the organic EL element 21 through the drive transistor 22. Consequently, the organic EL element 21 emits light with a luminance corresponding to the current value of the drive current I_{ds}.

### (Threshold Correction Preparation Period)

At time t₁₁, the operation enters a new display frame (a present display frame) for line-sequential scanning. As illustrated in FIG. 4B, the potential DS of the power-supply line 32 is switched from the high potential V_{ccp} to the second power-supply potential (hereinafter referred to as a “low potential”) Vᵢₙᵢ, which is sufficiently lower than V_{ofs}−Vₜₕ relative to the reference potential V_{ofs} of the signal line 33.

Let Vₜₕₑₗ be a threshold voltage of the organic EL element 21 and let V_{cath} be the potential (cathode potential) of the common power-supply line 34. In this case, when the low potential Vᵢₙᵢ is assumed to satisfy Vᵢₙᵢ<Vₜₕₑₗ+V_{cath}, the source potential Vₛ of the drive transistor 22 is substantially equal to the low potential Vᵢₙᵢ. As a result, the organic EL element 21 is put into a reverse-biased state and turns off the light emission.

Next, at time t₁₂, the potential WS of the scan line 31 transitions from a low-potential side toward a high-potential side, so that the write transistor 23 is put into a conductive state, as illustrated in FIG. 4C. At this point, since the reference potential V_{ofs} is supplied from the signal output circuit 60 to the signal line 33, the gate potential V_{g} of the drive transistor 22 acts as the reference potential V_{ofs}. The source potential Vₛ of the drive transistor 22 is equal to the potential Vᵢₙᵢ that is sufficiently lower than the reference potential V_{ofs}, i.e., is equal to the low potential Vᵢₙᵢ.

At this point, the gate-source voltage V_{gs} of the drive transistor 22 is equal to V_{ofs}−Vᵢₙᵢ. In this case, unless V_{ofs}−Vᵢₙᵢ is sufficiently larger than the threshold voltage Vₜₕ of the drive transistor 22, it is difficult to perform threshold correction processing described below. Thus, setting is performed so as to satisfy a potential relationship expressed by V_{ofs}−Vᵢₙᵢ>Vₜₕ.

Processing for initialization by fixing (setting) the gate potential V_{g} of the drive transistor 22 to the reference potential V_{ofs} and fixing the source potential Vₛ to the low potential Vᵢₙᵢ is processing for preparation (threshold correction preparation) before the threshold correction processing (threshold correction operation) described below is performed. Thus, the reference potential V_{ofs} and the low potential Vᵢₙᵢ serve as initialization potentials for the gate potential V_{g} and the source potential Vₛ of the drive transistor 22.

### (Threshold Correction Period)

Next, at time t₁₃, the potential DS of the power-supply line 32 is switched from the low potential Vᵢₙᵢ to the high potential V_{ccp}, as illustrated in FIG. 4D, and the threshold correction processing is started while the gate potential V_{g} of the drive transistor 22 is maintained at the reference voltage V_{ofs}. That is, the source potential Vₛ of the drive transistor 22 starts to increase toward a potential obtained by subtracting the threshold voltage Vₜₕ of the drive transistor 22 from the gate potential V_{g}.

Herein, the processing for changing the source potential Vₛ toward the potential obtained by subtracting the threshold voltage Vₜₕ of the drive transistor 22 from the initialization potential V_{ofs}, with reference to the initialization potential V_{ofs} of the gate potential V_{g} of the drive transistor 22, is referred to as “threshold correction processing”, for convenience of description. When the threshold correction processing progresses, the gate-source voltage V_{gs} of the drive transistor 22 eventually settles to the threshold voltage Vₜₕ of the drive transistor 22. A voltage corresponding to the threshold voltage Vₜₕ is stored by the storage capacitor 24.

In the period in which the threshold correction processing is performed (i.e., in a threshold correction period), the potential V_{cath} of the common power-supply line 34 is set so that the organic EL element 21 is put into a cutoff state, in order to cause current to flow to the storage capacitor 24 and to prevent current from flowing to the organic EL element 21.

Next, at time t₁₄, the potential WS of the scan line 31 transitions to the low-potential side, so that the write transistor 23 is put into a non-conductive state, as illustrated in FIG. 5A. At this point, the gate electrode of the drive transistor 22 is electrically disconnected from the signal line 33, so that the gate electrode of the drive transistor 22 enters a floating state. However, since the gate-source voltage V_{gs} is equal to the threshold voltage Vₜₕ of the drive transistor 22, the drive transistor 22 is in a cutoff state. Thus, almost no drain-source current I_{ds} flows to the drive transistor 22.

### (Signal Writing & Mobility Correction Period)

Next, at time t₁₅, as illustrated in FIG. 5B, the potential of the signal line 33 is switched from the reference potential V_{ofs} to the signal voltage V_{sig} of the video signal. Subsequently, at time t₁₆, the potential WS of the scan line 31 transitions to the high-potential side, so that the write transistor 23 enters a conductive state, as illustrated in FIG. 5C, to sample the signal voltage V_{sig} of the video signal and to write the signal voltage V_{sig} to the pixel 20.

When the write transistor 23 writes the signal voltage V_{sig}, the gate potential V_{g} of the drive transistor 22 becomes equal to the signal voltage V_{sig}. When the drive transistor 22 is driven with the signal voltage V_{sig} of the video signal, the threshold voltage Vₜₕ of the drive transistor 22 is cancelled out by a voltage corresponding to the threshold voltage Vₜₕ stored by the storage capacitor 24. Details of the principle of the threshold cancellation are described below.

At this point, the organic EL element 21 is in the cutoff state (a high impedance state). Thus, the current (the drain-source current I_{ds}) flowing from the power-supply line 32 to the drive transistor 22 in accordance with the signal voltage V_{sig} of the video signal flows to the equivalent capacitor of the organic EL element 21 and the auxiliary capacitor 25. As a result, charging of the equivalent capacitor of the organic EL element 21 and the auxiliary capacitor 25 is started.

As a result of the charging of the equivalent capacitor of the organic EL element 21 and the auxiliary capacitor 25, the source potential Vₛ of the drive transistor 22 increases with a lapse of time. Since variations in the threshold voltages Vₜₕ of the drive transistors 22 of the pixels have already been cancelled out at this point, the drain-source current I_{ds} of the drive transistor 22 depends on the mobility μ of the drive transistor 22. The mobility μ of the drive transistor 22 refers to mobility of a semiconductor thin film included in a channel of the drive transistor 22.

It is now assumed that the ratio of the voltage V_{gs} stored by the storage capacitor 24 to the signal voltage V_{sig} of the video signal (the ratio is referred to as a “write gain G”) is 1 (an ideal value). In this case, the source potential Vₛ of the drive transistor 22 increases to a potential expressed by V_{ofs}−Vₜₕ+ΔV, so that the gate-source voltage V_{gs} of the drive transistor 22 reaches a value expressed by V_{sig}−V_{ofs}+Vₜₕ−ΔV.

That is, an increase ΔV in the source potential Vₛ of the drive transistor 22 acts so that it is subtracted from the voltage (V_{sig}−V_{ofs}+Vₜₕ) stored by the storage capacitor 24, i.e., so that the electrical charge in the storage capacitor 24 is discharged. In other words, negative feedback corresponding to the increase ΔV in the source potential Vₛ is applied to the storage capacitor 24. Thus, the increase ΔV in the source potential Vₛ corresponds to the amount of negative feedback.

When negative feedback having the amount ΔV of feedback corresponding to the drain-source current I_{ds} flowing to the drive transistor 22 is applied to the gate-source voltage V_{gs} in the manner described above, it is possible to cancel the dependence of the drain-source current I_{ds} of the drive transistor 22 upon the mobility μ. This processing for cancelling the dependence on the mobility μ is mobility correction processing for correcting variations in the mobilities μ of the drive transistors 22 of the individual pixels.

More specifically, the higher the signal amplitude Vᵢₙ (=V_{sig}−V_{ofs}) of the video signal written to the gate electrode of the drive transistor 22, the larger the drain-source current I_{ds} is. Thus, the absolute value of the amount ΔV of negative feedback also increases. Accordingly, the mobility correction processing is performed in accordance with the light-emission luminance level.

When the signal amplitude Vᵢₙ of the video signal is constant, the absolute value of the amount ΔV of negative feedback increases as the mobility μ of the drive transistor 22 increases. Thus, variations in the mobilities μ of individual pixels can be reduced or eliminated. That is, the amount ΔV of negative feedback can also be referred to as the “amount of correction of the mobility correction processing”. Details of the principle of the mobility correction are described below.

### (Light Emission Period)

Next, at time t₁₇, the potential WS of the scan line 31 transitions to the low-potential side, so that the write transistor 23 is put into a non-conductive state, as illustrated in FIG. 5D. Consequently, the gate electrode of the drive transistor 22 is electrically disconnected from the signal line 33, so that the gate electrode of the drive transistor 22 enters a floating state.

In this case, when the gate electrode of the drive transistor 22 is in the floating state, the gate potential V_{g} also varies in conjunction with variations in the source potential Vₛ of the drive transistor 22, since the storage capacitor 24 is connected between the gate and the source of the drive transistor 22.

Such an operation in which the gate potential V_{g} of the drive transistor 22 varies in conjunction with variations in the source potential Vₛ, that is, an operation in which the gate potential V_{g} and the source potential Vₛ increases while the gate-source voltage V_{gs} stored in the storage capacitor 24 is maintained, is herein referred to as a “bootstrap operation”.

At the same time the gate electrode of the drive transistor 22 enters the floating state, the drain-source current I_{ds} of the drive transistor 22 starts to flow to the organic EL element 21, so that the anode potential of the organic EL element 21 increases in response to the drain-source current I_{ds}.

When the anode potential of the organic EL element 21 exceeds Vₜₕₑₗ+V_{cath}, the drive current starts to flow to the organic EL element 21 to thereby cause the organic EL element 21 to start light emission. The increase in the anode potential of the organic EL element 21 is due to an increase in the source potential Vₛ of the drive transistor 22. When the source potential Vₛ of the drive transistor 22 increases, the bootstrap operation of the storage capacitor 24 causes the gate potential V_{g} of the drive transistor 22 to increase in conjunction with the source potential Vₛ.

When the gain of the bootstrap is assumed to be 1 (an ideal value), the amount of increase in the gate potential V_{g} is equal to the amount of increase in the source potential Vₛ. Therefore, in the light-emission period, the gate-source voltage V_{gs} of the drive transistor 22 is maintained constant at V_{sig}−V_{ofs}+Vₜₕ−ΔV. At time t₁₈, the potential of the signal line 33 is switched from the signal voltage V_{sig} of the video signal to the reference voltage V_{ofs}.

In the above-described series of circuit operations, the processing operations of the threshold correction preparation, the threshold correction, the writing (signal writing) of the signal voltage V_{sig}, and the mobility correction are executed in one horizontal scan period (1H). The processing operations of the signal writing and the mobility correction are executed in parallel in the period of time t₁₆ to time t₁₇.

### [Division Threshold Correction]

Although the above description has been given of an example using a drive method for executing the threshold correction processing only once, the drive method is merely one example and is not limited thereto. For example, a drive method for performing so-called “division threshold correction” may also be employed. In the division threshold correction, in addition to the 1H period in which the threshold correction processing is performed in conjunction with the mobility correction and the signal write processing, the threshold correction processing is performed multiple times, i.e., in multiple horizontal scan periods in a divided manner, prior to the 1H period.

With the drive method for the division threshold correction, even when a time allocated to one horizontal scan period is reduced as a result of an increased number of pixels for a higher definition, a sufficient amount of time can be ensured in the multiple scan periods for the threshold correction periods. Thus, since a sufficient amount of time can be ensured as a threshold correction period even when the time allocated to one horizontal scan period is reduced, it is possible to reliably execute the threshold correction processing.

### [Principle of Threshold Cancellation]

The principle of the threshold cancellation (i.e., threshold correction) of the drive transistor 22 will now be described. Since the drive transistor 22 is designed so as to operate in the saturation region, it operates as a constant current source. As a result, a certain amount of drain-source current (drive current) I_{ds} flows from the drive transistor 22 to the organic EL element 21, and is given by:

I_{ds}=(½)·μ(W/L)Cₒₓ(V_{gs}−Vₜₕ)² (1)

where W indicates a channel width of the drive transistor 22, L indicates a channel length, and Cₒₓ indicates a gate capacitance per unit area.

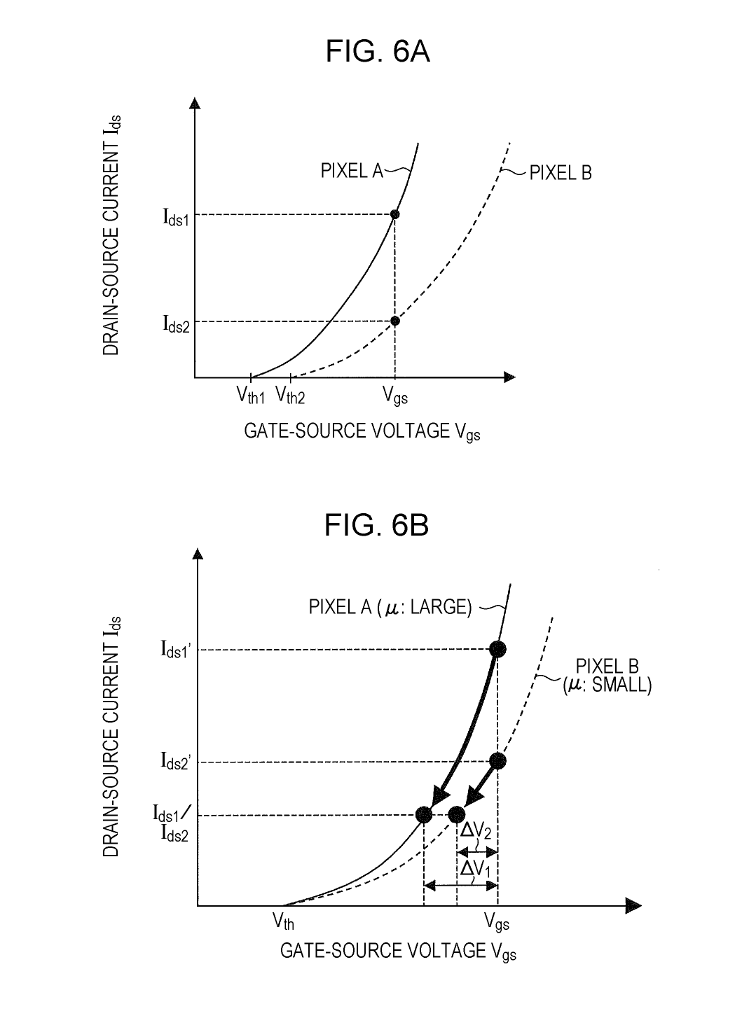

FIG. 6A is a graph illustrating a characteristic of the drain-source current I_{ds} of the drive transistor 22 versus the gate-source voltage V_{gs}. As illustrated in the graph in FIG. 6A, if no cancellation processing (correction processing) is performed on variations in the threshold voltage Vₜₕ of the drive transistor 22 in each individual pixel, the drain-source current I_{ds} corresponding to the gate-source voltage V_{gs} becomes I_{ds} when the threshold voltage Vₜₕ is Vₜₕ₁.

In contrast, when the threshold voltage Vₜₕ is Vₜₕ₂ (Vₜₕ₂>Vₜₕ₁), the drain-source current I_{ds} corresponding to the same gate-source voltage V_{gs} becomes I_{ds2} (I_{ds2}<I_{ds1}). That is, when the threshold voltage Vₜₕ of the drive transistor 22 varies, the drain-source current I_{ds} varies even when the gate-source voltage V_{gs} is constant.

On the other hand, in the pixel (pixel circuit) 20 having the above-described configuration, the gate-source voltage V_{gs} of the drive transistor 22 during light emission is expressed by V_{sig}−V_{ofs}+Vₜₕ−ΔV, as described above. Thus, substituting this expression into equation (1) noted above yields a drain-source current I_{ds} given by:

I_{ds}=/2)·μ(W/L)Cₒₓ(V_{sig}−V_{ofs}−ΔV)² (2)

That is, the term of the threshold voltage Vₜₕ of the drive transistor 22 is cancelled, so that the drain-source current I_{ds} supplied from the drive transistor 22 to the organic EL element 21 does not depend on the threshold voltage Vₜₕ of the drive transistor 22. As a result, even when the threshold voltage Vₜₕ of the drive transistor 22 is varied for each pixel by variations in the manufacturing process of the drive transistor 22, aging, or the like, the drain-source current I_{ds} does not vary. Accordingly, the light-emission luminance of the organic EL element 21 can be maintained constant.

### [Principle of Mobility Correction]

The principle of the mobility correction of the drive transistor 22 will be described next. FIG. 6B is a graph illustrating characteristic curves for comparison between a pixel A in which the mobility μ of the drive transistor 22 is relatively large and a pixel B in which the mobility μ of the drive transistor 22 is relatively small. When the drive transistor 22 is implemented by a polysilicon TFT or the like, variations in the mobilities μ of the pixels occur, such as those in pixels A and B.

A description will now be given of an example in which the signal amplitudes Vᵢₙ (=V_{sig}−V_{ofs}) at the same level are written to the gate electrodes of the drive transistors 22 of pixels A and B when mobilities μ in pixels A and B have variations. In this case, if no correction is performed on the mobilities a large difference occurs between a drain-source current I_{ds1}′ flowing through pixel A having a large mobility μ and a drain-source current I_{ds2}′ flowing through pixel B having a small mobility μ. When a large difference occurs between the drain-source currents I_{ds} in the pixels as a result of variations in the mobilities μ of the pixels, uniformity on the screen is impaired.

As is apparent from the transistor characteristic given by equation (1) noted above, the drain-source current I_{ds} increases as the mobility μ increases. Thus, the amount ΔV of negative feedback increases as the mobility μ increases. As illustrated in FIG. 6B, the amount ΔV₁ of negative feedback in pixel A having a large mobility μ is larger than the amount ΔV₂ of negative feedback in pixel B having a small mobility μ.

Accordingly, when the mobility correction processing is performed so that negative feedback having the amount ΔV of feedback corresponding to the drain-source current I_{ds} of the drive transistor 22 is applied to the gate-source voltage V_{gs}, a larger amount of negative feedback is applied as the mobility μ increases. As a result, it is possible to suppress variations in the mobilities μ of the pixels.

More specifically, when correction corresponding to the amount ΔV₁ of negative feedback is performed on pixel A having a large mobility μ, the drain-source current I_{ds} decreases significantly from I_{ds1}′ to I_{ds1}. On the other hand, since the amount ΔV₂ of feedback in pixel B having a small mobility μ is small, the drain-source current I_{ds} decreases from I_{ds2}′ to I_{ds2} and the amount of this decrease is not so large. As a result, the drain-source current I_{ds1} in pixel A and the drain-source current I_{ds2} in pixel B become substantially equal to each other, so that variations in the mobilities μ of the pixels are corrected.

In short, when pixels A and B having different mobilities μ exist, the amount ΔV₁ of feedback in pixel A having a large mobility μ is larger than the amount ΔV₂ of feedback in pixel B having a small mobility μ. That is, the larger the mobility μ of the pixel, the larger the amount of feedback ΔV is and also the larger the amount of decrease in the drain-source current I_{ds} is.

Thus, as a result of applying the negative feedback having the amount ΔV of feedback corresponding to the drain-source current I_{ds} of the drive transistor 22 to the gate-source voltage V_{gs}, the current values of the drain-source currents I_{ds} of the pixels having different mobilities μ become equal to each other. As a result, it is possible to correct variations in the mobilities μ of the pixels. That is, the mobility correction processing is processing in which the negative feedback having the amount ΔV of feedback (the amount of correction) corresponding to the current (drain-source current I_{ds}) flowing to the drive transistor 22 is applied to the gate-source voltage V_{gs} of the drive transistor 22, i.e., to the storage capacitor 24. The threshold correction and the mobility correction described above are operations that may or may not be performed in the present disclosure and the various corrections, light emissions, and so on described above are not limited to those operations and timings.

### 1-3. Selector Driving System

Reference back to FIG. 1, a signal source, for example, a data driver, is provided outside the display panel 70 to selectively supply the signal voltage V_{sig} of a video signal and the reference voltage V_{ofs} used for the threshold correction processing to the signal output circuit 60 on the display panel 70. Now, the signal output circuit 60 when the signal voltage V_{sig} of the video signal is supplied thereto as a display signal will be described for ease of understanding.

The signal output circuit 60 employs a selector driving system in order to reduce the number of outputs (the number of output terminals) of the data driver. The selector driving system is a system in which a unit (set) of multiple signal lines of the signal lines 33₁ to 33ₙ on the display panel 70 are assigned to one output of the data driver and the signal voltage V_{sig} time-sequentially output from the data driver is distributed to the signal lines of the unit in a time-divided manner (in a time-sharing manner).

In general, the number of outputs of the data driver and the number of signal lines 33₁ to 33ₙ on the display panel 70 are set equal to each other and the output terminals of the data driver and the signal lines 33₁ to 33ₙ on the display panel 70 are connected in a one-to-one correspondence. With this configuration, however, since n outputs of the data driver and n wires that provide electrical connections between the output terminals of the data driver and the display panel 70 are used and n terminals are also provided at the display panel 70 side, the configuration of the overall system is complicated.

In contrast, the selector driving system is used for the signal output circuit 60 and the outputs of the data driver and the signal lines 33₁ to 33ₙ on the display panel 70 are set in a one-to-x correspondence (x is an integer 2 or greater). The signal voltage V_{sig} time-sequentially output from one output terminal of the data driver is distributed in a time-divided manner to x signal lines allocated to the output terminal With this selector driving system, the number of outputs of the data driver, the number of wires between the data driver and the display panel 70, and the number of terminals at the display panel 70 side can be reduced to 1/x of the n signal lines 33₁ to 33ₙ.

For example, for a color organic EL display device in which three sub pixels (i.e., R (red), G (green), and B (blue) pixels) constitute one unit pixel that serves as a color image unit, it is preferable that the number “x” of signal lines which is a unit for employing the selector driving system, i.e., the number x of time divisions, be set to 3 (i.e., x=3) or a multiple thereof.

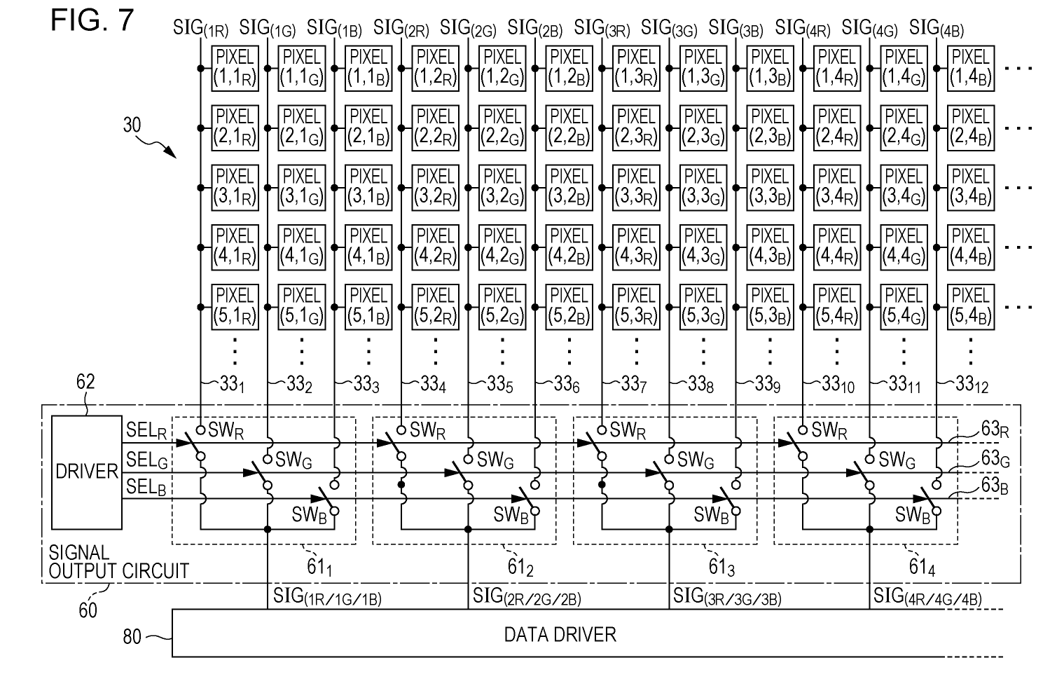

FIG. 7 is a circuit diagram illustrating one example of the configuration of the signal output circuit 60 employing the selector driving system. For simplicity of illustration, a pixel array with 5 rows by 12 columns is illustrated by way of example. This example also corresponds to a case in which the number x of time divisions is 3 (i.e., x=3) for the three sub pixels (R, G, and B sub pixels).

As illustrated in FIG. 7, the signal output circuit 60 includes selector circuits 61₁, 61₂, 61₃, 61₄, . . . , each being disposed for a corresponding unit of three pixel columns for the R, G, and B sub pixels, and a driver 62 for driving the selector circuits 61₁, 61₂, 61₃, 61₄, . . . . Each of the selector circuits 61₁, 61₂, 61₃, 61₄, . . . includes three switch elements SW_{R}, SW_{G}, and SW_{B} corresponding to the R, G, and B sub pixels.

A data driver 80 is provided outside the display panel 70 to serve as a signal source. Time-series signals SIG are input from the data driver 80 to the selector circuits 61₁, 61₂, 61₃, 61₄, . . . . More specifically, time-series signals SIG_{(1R/1G/1B)} are input to the selector circuit 61₁ and time-series signals SIG_{(2R/2G/2B)} are input to the selector circuit 61₂. Time-series signals SIG_{(3R/3G/3B)} are input to the selector circuit 61₃ and time-series signals SIG_{(4R/4G/4B)} are input to the selector circuit 61₄.

Selection signals SEL_{R}, SEL_{G}, and SEL_{B} corresponding to the respective colors are supplied from the driver 62 to the selector circuits 61₁, 61₂, 61₃, 61₄, . . . through control lines 63_{R}, 63_{G}, and 63_{B} as drive signals for three switch elements SW_{R}, SW_{G}, and SW_{B}. The selection signals SEL_{R}, SEL_{G}, and SEL_{B} are sequentially output from the driver 62 in order of R, G, and B pixel-row by pixel-row (line by line).

First, for the first row, the selection signal SEL_{R} is output from the driver 62 to the selector circuits 61₁, 61₂, 61₃, 61₄. As a result, the switch elements SW_{R} are turned on, so that the R signals SIG_{(1R)}, SIG_{(2R)}, SIG_{(3R)}, SIG_{(4R)}, . . . of the time-series signals are selected and are written to the signal lines 33₁, 33₄, 33₇, 33₁₀, . . . in the R pixel columns. Next, the selection signals SEL_{G} are output from the driver 62 to turn on the switch elements SW_{G}, so that the G signal SIG_{(1G)}, SIG_{(2G)}, SIG_{(3G)}, SIG_{(4G)}, . . . are selected and are written to the signal lines 33₂, 33₅, 33₈, 33₁₁, . . . in the G pixel columns.

Next, the selection signal SEL_{B} is output from the driver 62 to turn on the switch elements SW_{B}, so that the B signals SIG_{(1B)}, SIG_{(2B)}, SIG_{(3B)}, SIG_{(4B)}, . . . are selected and are written to the signal lines 33₃, 33₆, 33₉, 33₁₂, . . . in the B pixel columns. Thereafter, processing that is similar to that for the first row is performed to distribute, in a time-divided manner, the time-series signals SIG_{(1R/1G/1B)}, SIG_{(2R/2G/2B)}, SIG_{(3R/3G/3B)}, SIG_{(4R/4G/4B)}, . . . to three signal lines for R, G, and B by pixel row by pixel row (line by line).

Although the signal output circuit 60 described above has a configuration in which the driver 62 disposed at one side of the display panel 70 drives the switch elements SW_{R}, SW_{G}, and SW_{B} in the selector circuits 61₁, 61₂, 61₃, 61₄, . . . , the configuration is not limited thereto. For example, considering a propagation delay due to the control lines 63_{R}, 63_{G}, and 63_{B} or the like, the signal output circuit 60 may also have a configuration in which drivers 62 are disposed at two opposite sides of the display panel 70 so that the switch elements SW_{R}, SW_{G}, and SW_{B} are driven from the two opposite sides of the display panel 70. The expressions “one side” and “two opposite sides” of the display panel 70 also correspond to one side and two opposite sides, respectively, of the pixel array section 30 and also correspond to one side and two opposite sides, respectively, in the direction in which the selector circuits 61₁, 61₂, 61₃, 61₄, . . . are arranged.

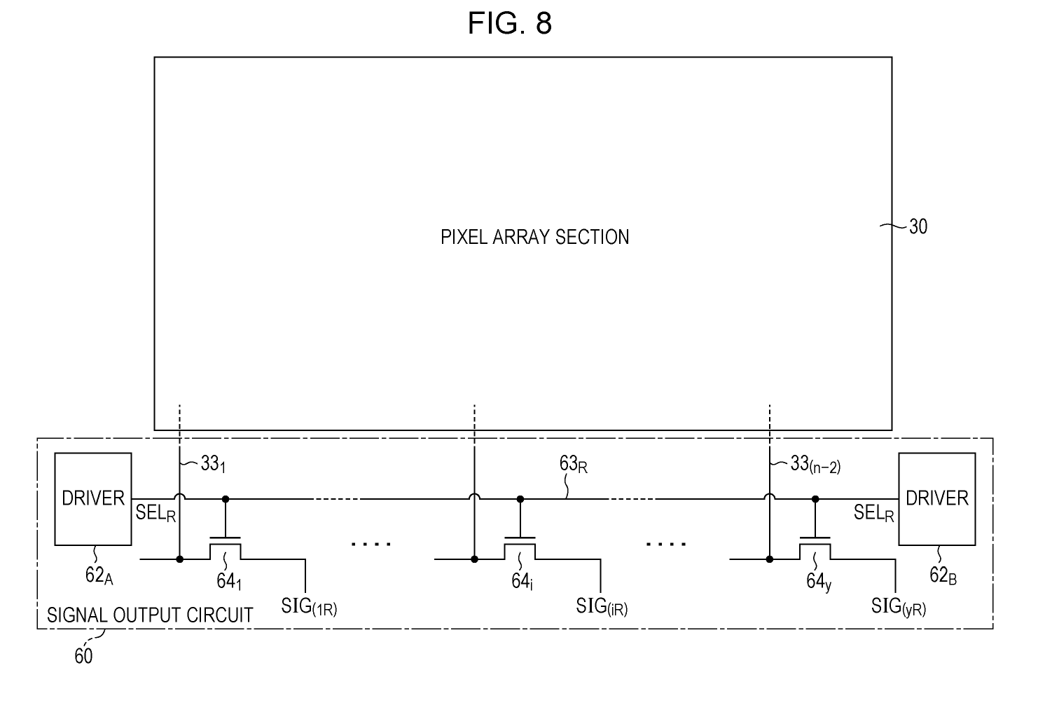

In the signal output circuit 60 employing the above-described selector driving system, transistors may be typically used as the switch elements SW_{R}, SW_{G}, and SW_{B} included in the selector circuits 61₁, 61₂, 61₃, 61₄, . . . . FIG. 8 illustrates an example of the signal output circuit 60 using transistors as the switch elements SW_{R}, SW_{G}, and SW_{B}.

For simplicity of illustration, FIG. 8 illustrates three transistors at two opposite end portions and the center portion with respect to the R switch elements SW_{R} when the switch elements SW_{R}, SW_{G}, and SW_{B} are driven from the two opposite sides in the direction in which they are arranged. Although each of the switch elements SW_{R}, SW_{G}, and SW_{B} is implemented by an n-channel transistor, the transistor type is not limited thereto. For example, each of the switch elements SW_{R}, SW_{G}, and SW_{B} may be implemented by a p-channel transistor or may be implemented by a transfer switch constituted by an n-channel transistor and a p-channel transistor connected in parallel.

As illustrated in FIG. 8, drivers 62_{A} and 62_{B} are disposed at two opposite sides of the pixel array section 30 and a control line 63_{R} is wired between the drivers 62_{A} and 62_{B} to transmit selection signals (drive signals) SEL_{R}. Selection transistors 64 are arranged along the direction in which the control line 63_{R} extends. Gate electrodes of the selection transistors 64 are connected to the control line 63_{R}. In this example, since the number x of time divisions is 3, y selection transistors 64₁ to 64_{y} (y=n/3) are arranged for n horizontal pixels as the R selection transistors 64.

FIG. 8 illustrates, of the y selection transistors 64₁ to 64_{y}, the selection transistors 64₁ and 64_{y} at two opposite end portions and the selection transistor 64ᵢ (i=y/2) at the center portion. Hereinafter, one source/drain included in each of the selection transistors 64₁, 64ᵢ, and 64_{y} and connected to the corresponding signal line 33 is referred to as a “source” and another source/drain to which a corresponding one of the time-series signals SIG_{(1R/iR/yR)} is input is referred to as a “drain”.

### 1-4. Failure Caused by Wiring Resistance and Wiring Capacitance of Control Line

When the transistors arranged along the direction in which the control line extends are driven with drive signals supplied through the control line as in the case of the selector-driving-system signal output circuit 60 described above, a failure as described below is caused by a wiring resistance and a wiring capacitance of the control line. The failure will be described below in conjunction with an example in the case of the selector-driving-system signal output circuit 60 illustrated in FIG. 8.

The control line 63_{R} through which the drive signals, i.e., the selection signals SEL_{R}, output from the drivers 62_{A} and 62_{B} are transmitted has a wiring resistance and a wiring capacitance. The presence of the wiring resistance and the wiring capacitance causes the waveform of the selection signal SEL_{R} applied to the gate electrodes of the selection transistors 64₁ to 64_{y} to differ between a portion close to the driver 62_{A} or 62_{B} and a portion far therefrom, i.e., to differ depending on the distances of the selection transistors 64₁ to 64_{y} from the drivers 62_{A} and 62_{B}.

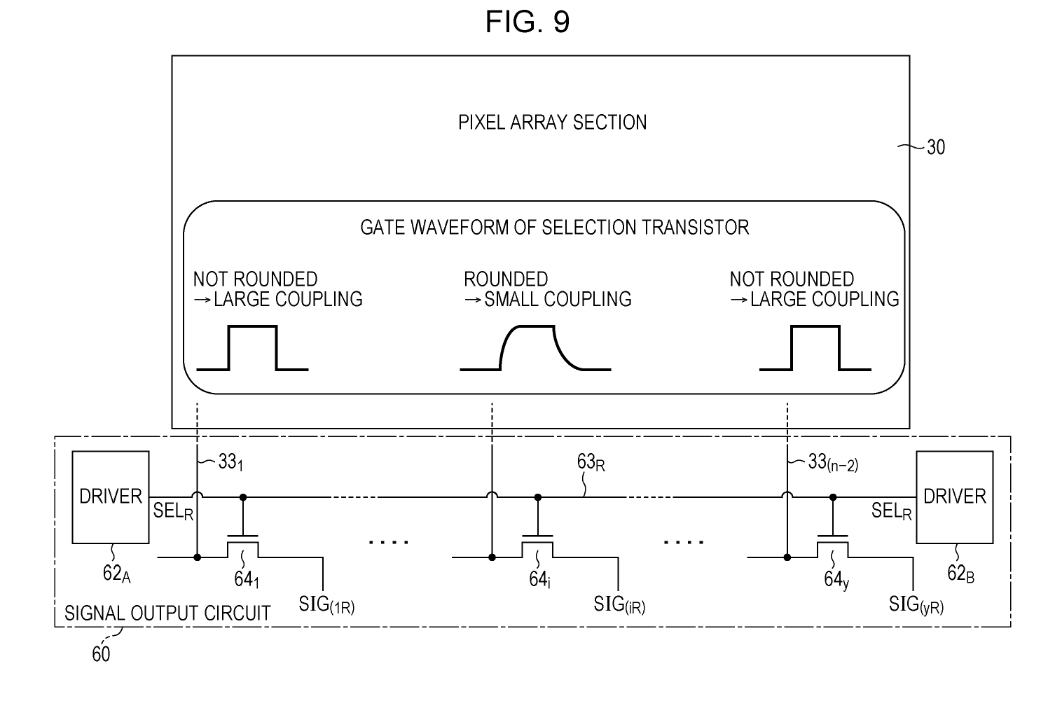

In the case of the two-opposite-side-driving system illustrated in FIG. 8, the selection transistors 64₁ and 64_{y} at two opposite end portions of the pixel array section 30 are the closest portions and the selection transistor 64ᵢ at the center portion is the farthest portion. In this case, the selection signals SEL_{R} output from the drivers 62_{A} and 62_{B} are assumed to have rectangular waveforms. In this case, the gate input waveforms of the selection transistors 64₁ and 64_{y} are rectangular waveforms, whereas the gate input waveform of the selection transistor 64ᵢ at the center portion is rounded by an influence of the wiring resistance and the wiring capacitance of the control line 63_{R}, i.e., the falling edge of the waveform becomes gentle, as illustrated in FIG. 9.

When the gate input waveform of each of the selection transistors 64₁ to 64_{y} falls, capacitive coupling due to parasitic capacitance between the gate and the source reduces the source voltage, i.e., reduces the potential of the signal line 33. In this case, in the selection transistors 64₁ and 64_{y} that are respectively the closest to the drivers 62_{A} and 62_{B}, the gate input waveforms are not rounded, i.e., are steep, so that the amounts of coupling also increase. On the other hand, in the selection transistor 64ᵢ that is the farthest from the drivers 62_{A} and 62_{B}, the gate input waveform is rounded, i.e., is gentle, so that the amount of coupling decreases.

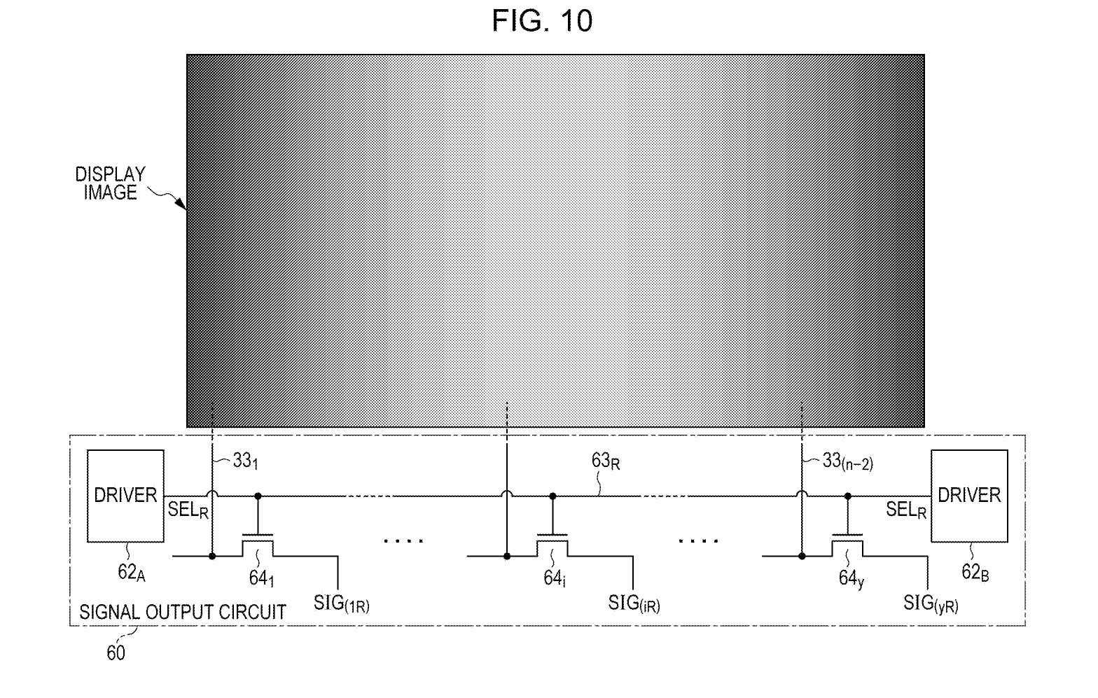

As a result, even when the signal voltages V_{sig} at the same level are written to all pixel columns, a luminance difference occur between the portion where the amount of coupling is large and the portion where the amount of coupling is small. More specifically, at the portion where the amount of coupling is large, the potential of the signal line 33 exhibits a large voltage drop relative to the written signal voltage V_{sig}. Consequently, as illustrated in FIG. 10, images displayed at two opposite end portions of the screen become dark. On the other hand, at the portion where the amount of coupling is small, the potential of the signal line 33 exhibits a small voltage drop relative to the written signal voltage V_{sig}. Consequently, an image displayed at the center portion of the screen becomes bright.

That is, since the gate input waveforms of the selection transistors 64₁ to 64_{y} are rounded by the wiring resistance and the wiring capacitance of the control line 63_{R}, the amounts of coupling differ depending on the positions of the selection transistors 64 in the direction in which the control line 63_{R} extends. The difference in the amounts of coupling, the difference being caused by the difference in the transistor positions in the direction in which the control line 63_{R} extends, causes luminance non-uniformity in the image displayed.

Although the failure caused by the wiring resistance and the wiring capacitance of the control line has been described above in conjunction with an example of the two-opposite-side-driving system signal output circuit 60 for driving the selection transistors 64 (64₁ to 64_{y}) from two opposite sides of the display panel 70, the same can also be said of the one-side-driving system signal output circuit 60.

The same can also be said of not only the selection transistors 64 in the signal output circuit 60, but also, for example, the write transistors 23 driven with the write scan signals WS output from the write scan circuit 40 illustrated in FIG. 1. More specifically, since the scan lines 31, which are control lines, also have a wiring resistance and a wiring capacitance, they cause rounding of the waveforms of the write scan signals WS.

### 2. Embodiments

The technology of the present disclosure is aimed to achieve constant driving with a drive signal output from a driver regardless of a position in the direction in which the control line extends. To this end, according to an embodiment of the present disclosure, the parasitic capacitances between the gates and the sources/drains of the transistors arranged along the direction in which the control line extends are varied in accordance with the distances of the transistors from the driver in the direction in which the control line extends.

In the case of the selector-driving-system signal output circuit 60 described above, the driver corresponds to the drivers 62_{A} and 62_{B}, the drive signal output from the driver corresponds to the selection signals SEL_{R}, and the control line corresponds to the control line 63_{R}. The transistors arranged along the direction in which the control line extends correspond to the selection transistors 64₁ to 64_{y}.

Upon transition of the drive signal supplied to the gate electrode of each transistor, the capacitive coupling due to the parasitic capacitance between the gate and the source causes the source voltage to vary. As is apparent from the above description, the amount of coupling in this case depends on the transition waveform of the drive signal and the parasitic capacitance between the gate and the source. That is, when the transition waveform of the drive signal is steep (i.e., is not rounded), the amount of coupling is large, and when the transition waveform is gentle (i.e., is rounded), the amount of coupling is small. When the parasitic capacitance between the gate and the source is large, the amount of coupling is large, and when the parasitic capacitance is small, the amount of coupling is small.

Thus, varying the parasitic capacitances between the gates and the sources of the transistors in accordance with the distances thereof from the driver makes it possible to substantially equalize the amounts of coupling, regardless of the distances from the driver in the direction in which the control line extends. Since this arrangement can achieve constant driving of the transistors with the drive signal output from the driver regardless of the positions of the transistors in the direction in which the control line extends, it is possible to reduce the luminance non-uniformity caused by a difference in the amounts of coupling.

Specific embodiments, i.e., first and second embodiments, for realizing the technology of the present disclosure will be described below. In the first embodiment, a case in which the present disclosure is applied to the selection transistors 64₁ to 64_{y} in the selector-driving-system signal output circuit 60 is described, and in the second embodiment, a case in which the present disclosure is applied to the write transistors 23 in the pixels 20 is described.

### 2-1. First Embodiment

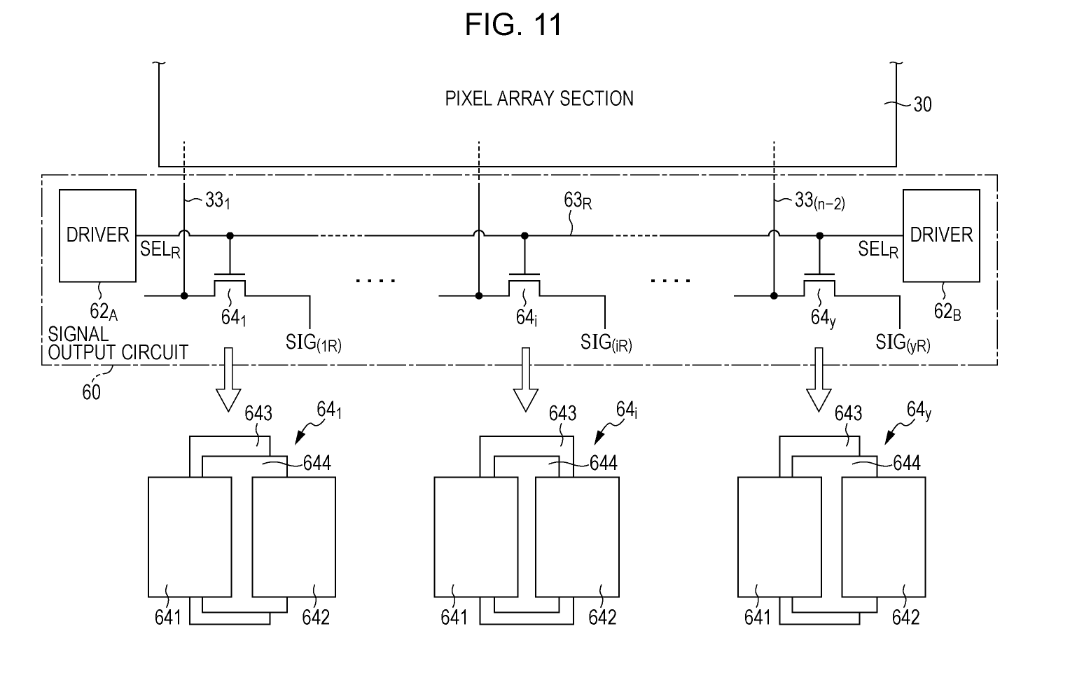

FIG. 11 illustrates the first embodiment in which the present disclosure is applied to the selection transistors 64₁ to 64_{y} in the selector-driving-system signal output circuit 60.

The signal output circuit 60 includes selector circuits 61₁, 61₂, 61₃, 61₄, . . . , each being arranged for a corresponding unit of three pixel columns for the R, G, and B sub pixels, and a driver 62 for driving the selector circuits 61₁, 61₂, 61₃, 61₄, . . . (as illustrated in FIG. 7). Three switch elements SW_{R}, SW_{G}, and SW_{B} constituting each of the selector circuits 61₁, 61₂, 61₃, 61₄, . . . and corresponding to the R, G, and B sub pixels are implemented by transistors.

FIG. 11 illustrates three selection transistors 64₁, 64_{y}, and 64ᵢ at two opposite end portions and the center portion with respect to the R switch elements SW_{R} in the signal output circuit 60 in which the drivers 62_{A} and 62_{B} drive the transistors from two opposite sides in the transistor arrangement directions. The sources of the selection transistors 64₁, 64ᵢ, and, 64_{y} are connected to the corresponding signal lines 33 and time-series signals SIG_{(1R, iR, yR)} are input to the drains of the selection transistors 64₁, 64ᵢ, and, 64_{y}.

As described above, during transition, i.e., falling, of the selection signal SEL_{R} supplied to the gate electrode of each of the selection transistors 64₁ to 64_{y}, the capacitive coupling due to the parasitic capacitance between the gate and the source causes the source voltage to vary. The amount of coupling at this point depends on the falling edge of the selection signal SEL_{R} and the parasitic capacitance between the gate and the source of each of the selection transistors 64₁ to 64_{y}.

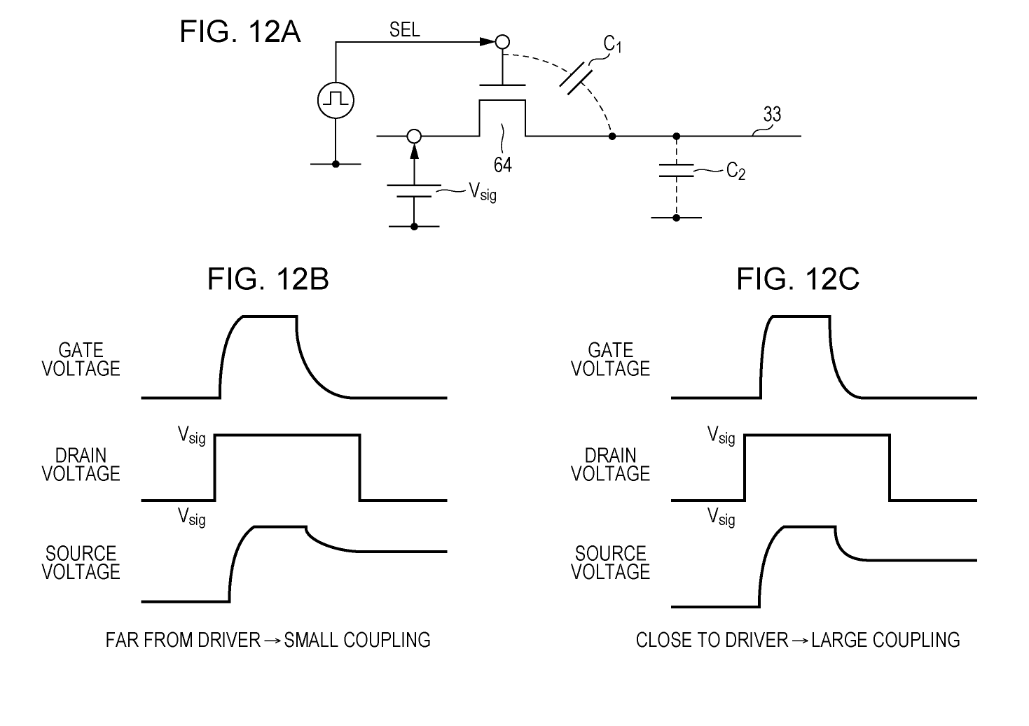

That is, when the falling edge of the selection signal SEL_{R} is steep (i.e., is not rounded), the amount of coupling is large, and when the falling edge is gentle (i.e., is rounded), the amount of coupling is small (see FIG. 12B). When the parasitic capacitance between the gate and the source of each of the selection transistors 64₁ to 64_{y} is large, the amount of coupling is large, and when the parasitic capacitance is small, the amount of coupling is small (see FIG. 12C).

Accordingly, the parasitic capacitances between the gates and the sources of the selection transistors 64₁ to 64_{y} are varied in accordance with the distances thereof from the closer one of the drivers 62_{A} and 62_{B}, i.e., in accordance with the wiring distances on the control line 63_{R} from the driver 62_{A} or 62_{B}. With this arrangement, the amounts of coupling can be substantially equalized regardless of the wiring distances from the driver 62_{A} or 62_{B} in the direction in which the control line 63_{R} extends. As a result, it is possible to achieve constant driving of the selection transistors 64₁ to 64_{y} with the selection signals SEL_{R} output from the drivers 62_{A} and 62_{B}, regardless of the transistor positions in the direction in which the control line 63_{R} extends.

In the present embodiment, as a scheme for varying the parasitic capacitances between the gates and the sources of the selection transistors 64₁ to 64_{y} in accordance with the wiring distances on the control line 63_{R}, a scheme for varying the areas in which the gate electrodes and the source regions overlap each other (the areas are hereinafter referred to as “gate-source overlap areas”) in accordance with the wiring distance is employed by way of example.

More specifically, in the example of FIG. 11, the gate-source overlap areas of the selection transistors 64₁ and 64_{y} at two opposite end portions of the panel which are the closest to the drivers 62_{A} and 62_{B}, respectively, are minimized. A reduction in the gate-source overlap area provides a relatively small parasitic capacitance. The gate-source overlap area of the selection transistor 64ᵢ at the panel center portion which is the farthest from the drivers 62_{A} and 62_{B} is maximized. An increase in the gate-source overlap area provides a relatively large parasitic capacitance.

For varying the gate-source overlap areas, for example, in FIG. 11, a scheme for varying the size of a gate electrode 643 with the sizes of a source region 641 and a drain region 642 being fixed may be employed. More specifically, the scheme may be realized by varying the width of the gate electrode 643 in the channel length direction (the left-and-right direction in FIG. 11) with the widths of the source region 641 and the drain region 642 being fixed in the channel length direction. It can be seen from FIG. 11 that the widths of the gate electrodes 643 of the selection transistors 64₁ and 64_{y} at two opposite end portions of the panel are reduced compared to the width of the gate electrode 643 of the selection transistor 64ᵢ at the panel center portion.

The capacitive coupling due to the parasitic capacitance between the gate and the source of each of the selection transistors 64 (64₁ to 64_{y}) will now be described with reference to a schematic diagram in FIG. 12A.

In the schematic diagram in FIG. 12A, a parasitic capacitance C₁ exists between the gate and the source of the selection transistor 64. The signal line 33 connected to the source has a wiring capacitance C₂. When coupling due to the parasitic capacitance C₁ occurs at the onset of dropping of the selection signal SEL, applied to the selection transistor 64, from a high voltage HSW_H to a low voltage HSW_L, a potential V_{sig}′ of the signal line 33 varies as given by:

V_{sig}′=V_{sig}−{C₁/(C₁+C₂)}(HSW_{—}H−HSW_{—}L).

In this case, since the selection transistor 64 is in a linear region, current I_{ds} flows to the selection transistor 64. Letting Vₜₕ be the threshold voltage of the selection transistor 64, the current I_{ds} at this point is given by:

I_{ds}={HSW_{—}L−V_{sig}′−Vₜₕ)(V_{sig}−V_{sig}′)−(½)(V_{sig}−V_{sig})²}.

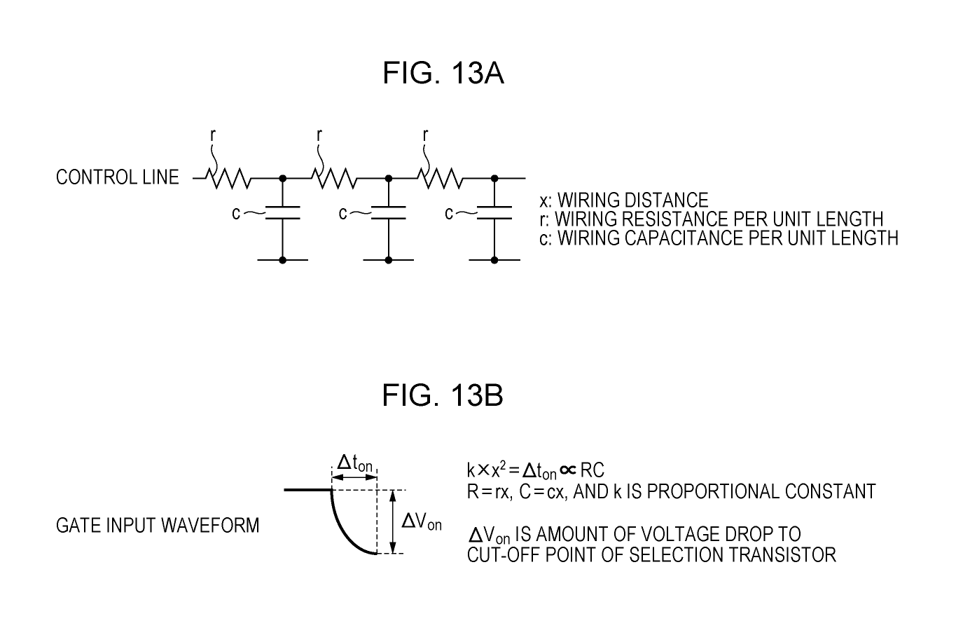

In this case, as illustrated in FIGS. 13A and 13B, letting x be the wiring distance on the control line 63 (corresponding to the control line 63_{R} illustrated in FIG. 11), letting r be the wiring resistance per unit length, and letting c be the wiring capacitance per unit length, the wiring resistance R of the signal line 33 is given by R=rx and the wiring capacitance C is given by C=cx. Letting Δtₒₙ be time taken for the gate voltage of the selection transistor 64 to drop to a cut-off point (this amount of voltage drop is indicated by ΔVₒₙ), Δtₒₙ∝RC is given. Therefore, Δtₒₙ=k×x² is satisfied, where k indicates a proportional constant.

Upon flow of the current I_{ds} to the selection transistor 64, the source voltage of the selection transistor 64 is reduced by an amount given by I_{ds}×Δₜₒₙ/C₂. The reduced source voltage at this point is indicated by V_{sig}″. Since the time Δtₒₙ at the onset of dropping from the high voltage HSW_H to the low voltage HSW_L when the waveform is not rounded is short, the source voltage V_{sig}″ is lower than the voltage at the onset of dropping when the waveform is rounded.

Subsequently, when the low voltage HSW_L drops continuously, the selection transistor 64 enters a saturation region temporarily, and when the low voltage HSW_L drops further continuously, the selection transistor 64 enters an OFF region. When the selection transistor 64 enters the OFF region, almost no current flows to the selection transistor 64. Thus, because of the rounding of the falling edge of the selection signal SEL the amounts of coupling becomes almost the same.

Let Iₒₙ be an ON current of the selection transistor 64. The ON current Iₒₙ is given by Iₒₙ∝W×μ/L, where W indicates the channel width of the selection transistor 64, L indicates the channel length, and μ indicates the mobility. Letting S be the gate-source overlap area, the parasitic capacitance C₁ between the gate and the source of the selection transistor 64 can be expressed by C₁=α×S (α indicates a constant ∝).

With those variables, the amount ΔVₛ of change in the source voltage of the selection transistor 64 is expressed by:

$$\begin{matrix}Δ {V}_{s} = Δ {V}_{on} \times {C}_{1} / ( {C}_{1} + {C}_{2} ) - {I}_{on} \times Δ {t}_{on} / ( {C}_{1} + {C}_{2} ) \\ = Δ {V}_{on} \times α \times S / ( α \times S + {C}_{2} ) - {I}_{on} \times k \times {x}^{2} / ( α \times S + {C}_{2} ) .\end{matrix}$$

This equation can be rewritten as:

S=(ΔVₛ×C₂+Iₒₙ×k×x²)/α×(ΔVₒₙ−ΔVₛ).

The gate-source overlap areas S are varied in accordance with the corresponding wiring distances x so that the amounts ΔVₛ of change in the source voltages of the selection transistors 64 during transition (i.e., falling) of the selection signal SEL become constant regardless of the wiring distances x on the control line 63 from the driver 62. Such an arrangement makes it possible to substantially equalize the amounts of coupling, regardless of the positions of the selection transistors 64 in the direction in which the control line 63 extends. Thus, constant driving of the transistors 64 with the selection signal SEL output from the driver 62 can be achieved regardless of the positions of the transistors 64 in the direction in which the control line 63 extends, thus making it possible to reduce the luminance non-uniformity caused by a difference in the amounts of coupling.

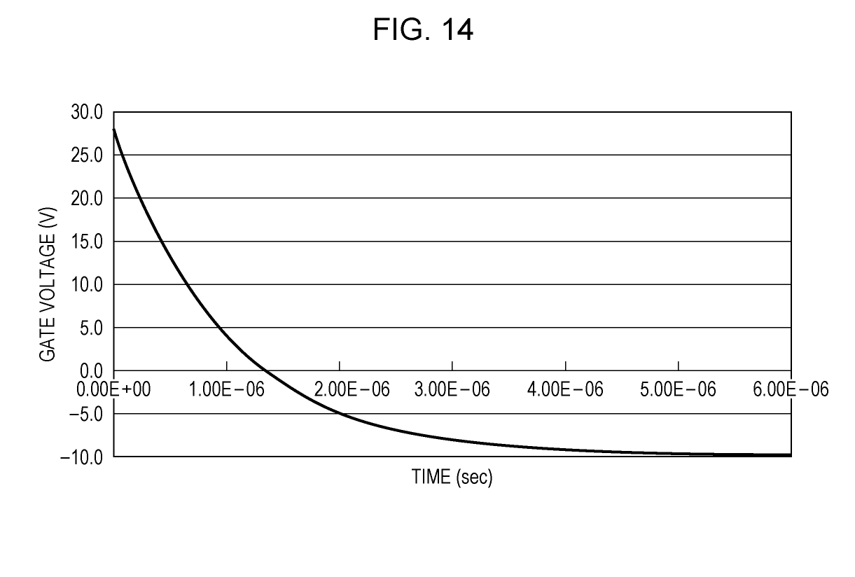

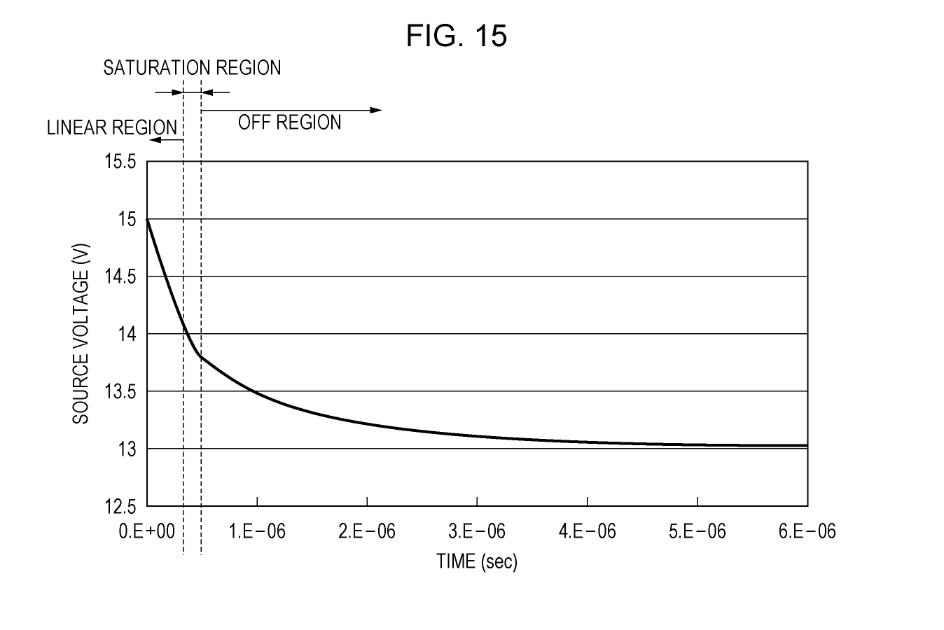

FIGS. 14 and 15 illustrate simulation results with respect to coupling of the selection transistor 64. These simulation results correspond to, for example, a case in which the parasitic capacitance C₁ between the gate and the source of the selection transistor 64 is 100 fF (when it is turned off) and the wiring capacitance C₂ of the signal line 33 is 3 pF. FIG. 14 illustrates a simulation result with respect to the gate voltage of the selection transistor 64. FIG. 15 illustrates a simulation result with respect to the source voltage of the selection transistor 64.

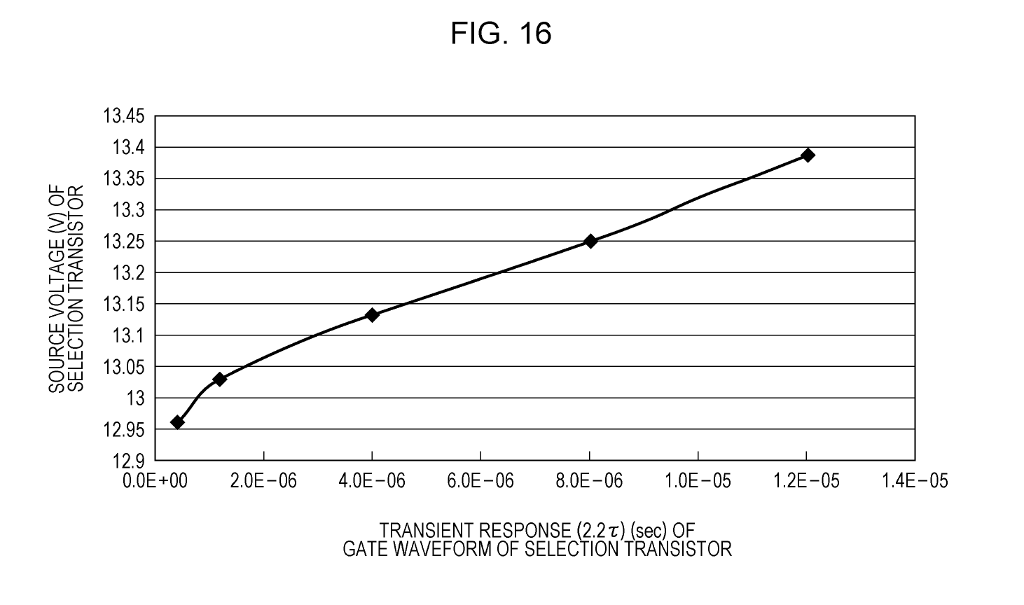

FIG. 16 illustrates a transient response of the gate waveform (gate input waveform) of the selection transistor 64 versus the source voltage of the selection transistor 64. As illustrated in FIG. 16, the source voltage at a portion where the transition waveform of the gate input is not rounded eventually becomes lower than the source voltage at a portion where the waveform is rounded. From such a relationship between the transient response of the gate waveform and the source voltage, it is preferable to reduce the parasitic capacitance C₁ between the gate and the source of the selection transistor 64 with respect to the portion where the transition waveform is not rounded, to thereby reduce the amount of coupling and to suppress the amount of reduction in the source voltage.

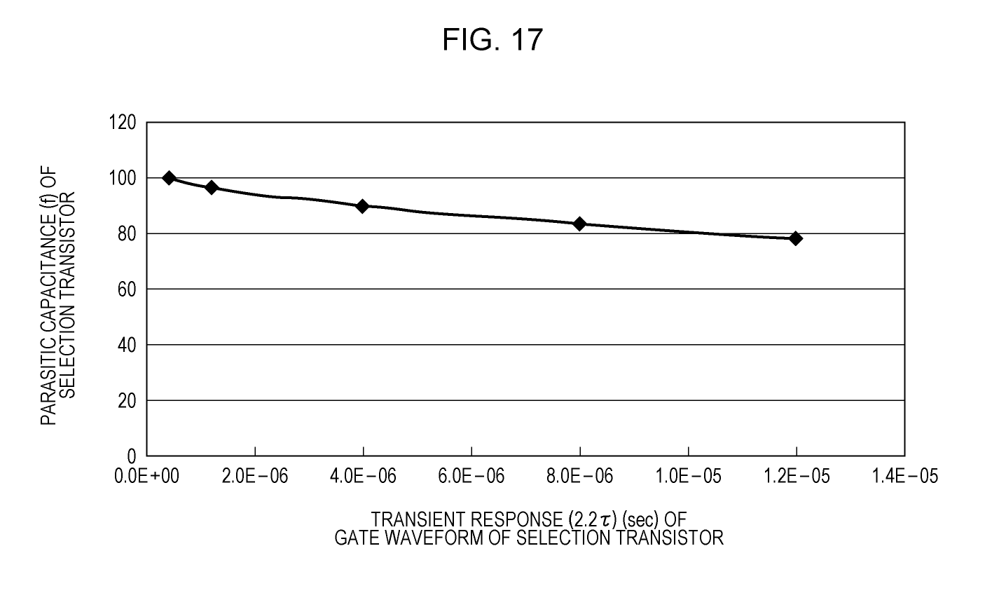

FIG. 17 illustrates the transient response of the gate waveform (gate input waveform) of the selection transistor 64 versus the parasitic capacitance C₁ between the gate and the source of the selection transistor 64. FIG. 17 illustrates one example of how the parasitic capacitance C₁ is to be set in order to reduce or eliminate a difference between the source voltages of the selection transistors 64, the difference being caused by a transient-response difference between the gate waveforms of the selection transistors 64.

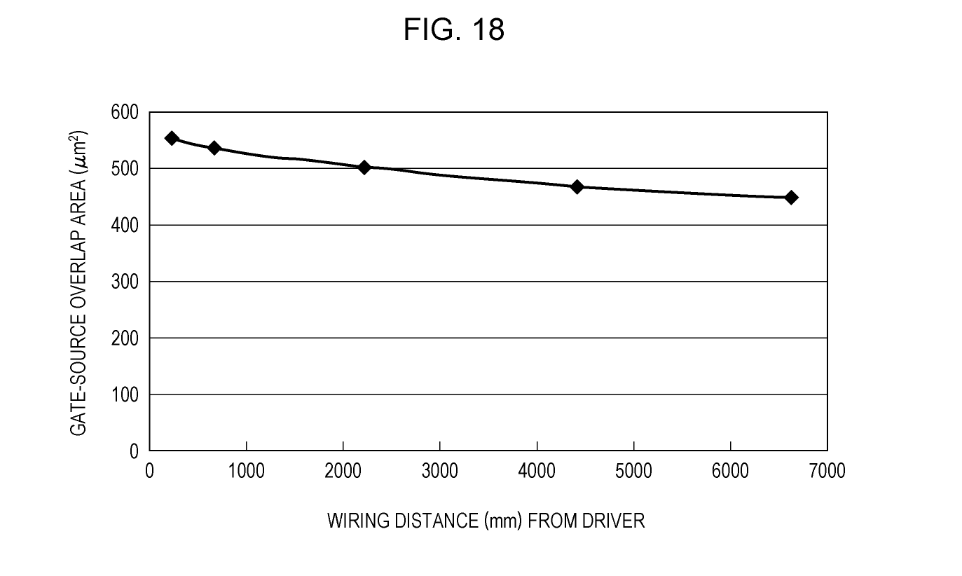

FIG. 18 illustrates the wiring distance from the driver 62 (62_{A} or 62_{B}), i.e., the distance from the driver 62 in the direction in which the control line 63 extends, versus the gate-source overlap area of the selection transistor 64. The above-described simulation results also show that the amounts of coupling can be equalized by varying the gate-source overlap areas S in accordance with the wiring distances x from the driver 62 (62_{A} or 62_{B}) and in accordance with the above-noted expression of the relationship between the wiring distance x and the gate-source overlap area S.

Although the two-opposite-side-driving system signal output circuit 60 in which the drivers 62_{A} and 62_{B} are disposed at two opposite sides of the display panel 70 to drive the selection transistors 64 from the two opposite sides of the panel has been described in the above embodiments by way of example, the driving system is not limited to the two-opposite-side-driving system. That is, the same as for the case of the two-opposite-side-driving system can also be said of the one-side driving system in which the driver 62 is disposed at one side of the display panel 70 to drive the selection transistors 64 from one side of the panel. The expressions “one side” and “two opposite sides” of the display panel 70 also correspond to one side and two opposite sides, respectively, of the pixel array section 30 and also correspond to one side and two opposite sides, respectively, in the direction in which the rows of the selection transistors 23 are arranged.

More specifically, in the one-side-driving system signal output circuit 60, the gate-source overlap areas S of the selection transistors 64 may also be varied from one side to the other side of the display panel 70 in accordance with the wiring distances x from the driver 62. Such an arrangement makes it possible to substantially equalize the amounts of coupling, regardless of the positions of the selection transistors 64 in the direction in which the control line 63 extends, as in the case of the two-opposite-side-driving system.

In the case of the two-opposite-side-driving system, the expression “in accordance with the wiring distance x from the drover 62” means “in accordance with the wiring distance x from the closer one of the two drivers 62_{A} and 62_{B}. This is because, in the case of the two-opposite-side-driving system, each of the selection transistor 64 is driven with the selection signals SEL output from the closer one of the drivers 62_{A} and 62_{B}.

In the present embodiment, although the scheme for varying the gate-source overlap areas in accordance with the wiring distances has been employed as the scheme for varying the parasitic capacitances between the gates and the sources of the selection transistors 64₁ to 64_{y} in accordance with the wiring distances on the control line 63_{R}, this is merely one example. Another possible scheme is a scheme for varying the thickness, a dielectric constant, or the like of an insulating film 644 (which is a dielectric) interposed between the source region 641/the drain region 642 and the gate electrode 643 in FIG. 11 in accordance with the wiring distance.

### 2-2. Second Embodiment

Next, a description will be given of a second embodiment in which the present disclosure is applied to the write transistors 23 in the pixels 20.

As described in section <1. Organic EL Display Device to which Embodiment of Present Disclosure is Applied>, each pixel 20 has the write transistor 23 for sampling and writing the signal voltage V_{sig} of a video signal. As illustrated in FIG. 2, each write transistor 23 is driven with the write scan signal WS output from the write scan circuit 40 and transmitted through the scan line 31 wired along the pixel row.

Each scan line 31 (which also serves as a control line) through which the write scan signal WS output from the write scan circuit 40 is transmitted to the pixels 20 in the corresponding pixel row has a wiring resistance and a wiring capacitance. The waveform of the write scan signal WS is rounded by the wiring resistance and the wiring capacitance of the scan line 31, as the wiring distance on the scan line 31 from the write scan circuit 40 (which is a driver for the write transistor 23) increases.

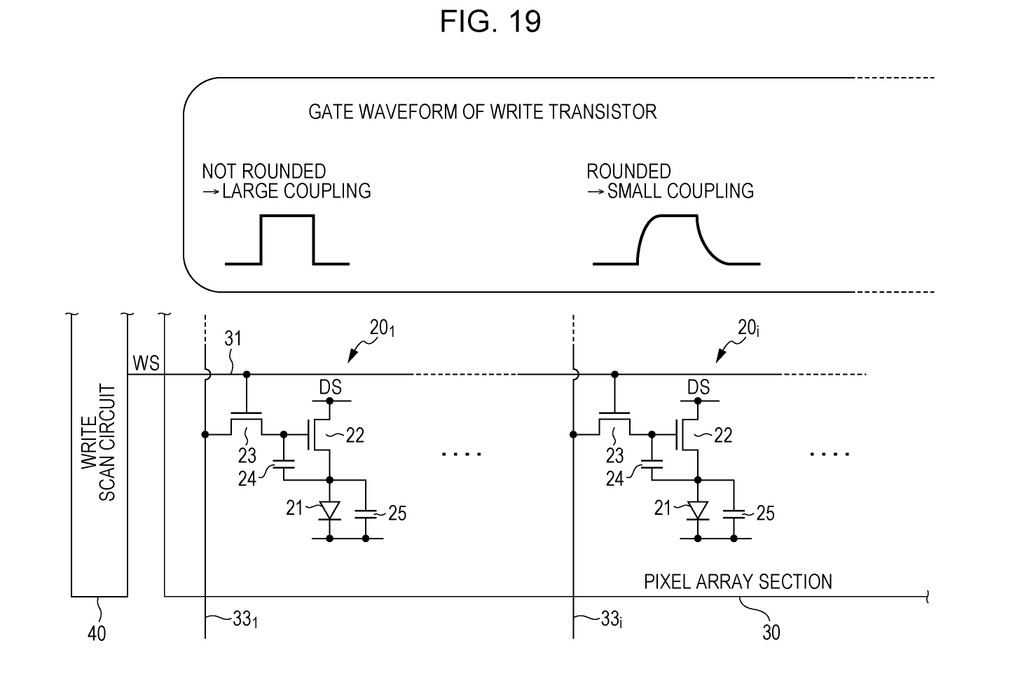

A description will be given in more detail with reference to FIG. 19. In FIG. 19, a pixel 20₁ located at the closest position to the write scan circuit 40 and a pixel 20ᵢ located at a farther position from the write scan circuit 40 than the pixel 20₁ will now be discussed assuming that the write scan signal WS output from the write scan circuit 40 has a rectangular waveform by way of example. In this case, the gate input waveform of the write transistor 23 in the pixel 20₁ is a rectangular waveform, whereas the gate input waveform of the write transistor 23 in the pixel 20ᵢ is rounded by an influence of the wiring resistance and the wiring capacitance of the scan line 31.

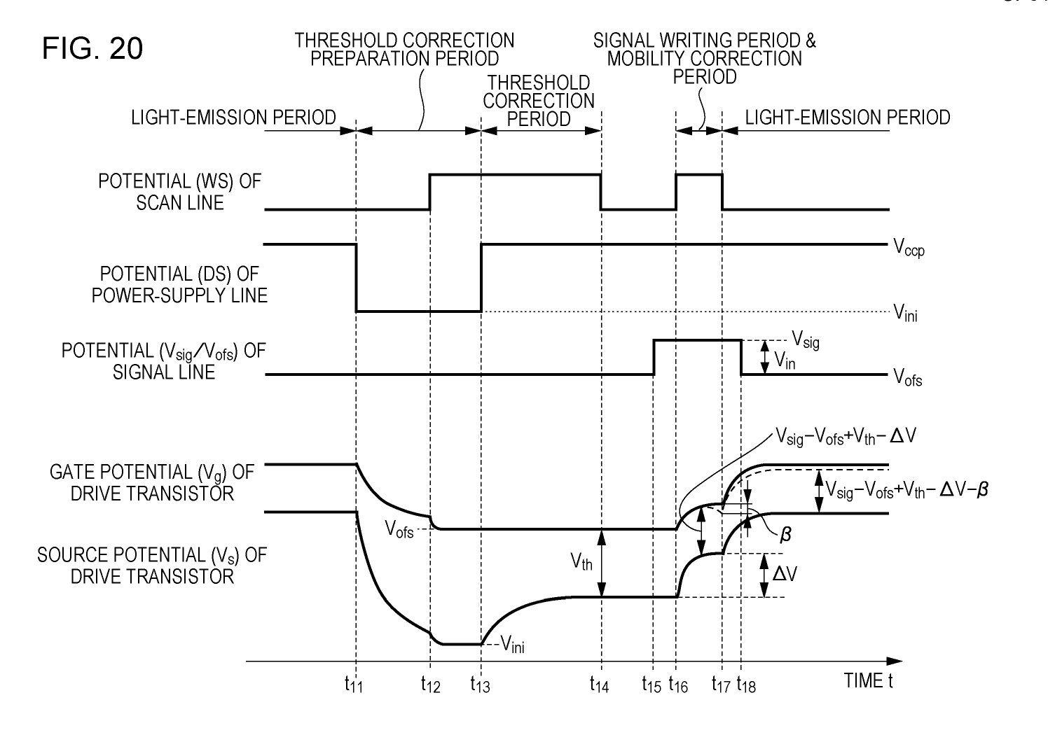

When the gate input waveform of the write transistor 23 in each of the pixels 20₁ and 20ᵢ falls, the capacitive coupling due to the parasitic capacitance between the gate and the source causes the source potential, i.e., the gate potential of the drive transistor 22, to decrease by an amount corresponding to β, as indicated by a broken line in FIG. 20. In this case, since the gate input waveform of the write transistor 23 in the pixel 20₁ located at the closest position to the write scan circuit 40 is not rounded (i.e., is steep), the amount of coupling is also the largest. On the other hand, since the gate input waveform of the write transistor 23 in the pixel 20ᵢ located at the farther position from the write scan circuit 40 than the pixel 20₁ is rounded (i.e., is gentle), the amount of coupling is small compared to the amount of coupling in the pixel 20₁.

When the gate potential of the drive transistor 22 is reduced by the capacitive coupling, the voltage across the storage capacitor 24, i.e., the gate-source voltage V_{gs} of the drive transistor 22, is reduced by an amount corresponding to the gate-potential drop β. Since the drive current supplied from the drive transistor 22 to the organic EL element 21, i.e., the light-emission luminance of the organic EL element 21, is determined by the gate-source potential V_{gs}, the reduction in the gate-source voltage V_{gs} causes the light-emission luminance of the organic EL element 21 to decrease. Even when the write transistors 23 write the signal voltages V_{sig} at the same level, a luminance difference occurs between the pixel having a large amount of coupling and the pixel having a small amount of coupling to thereby cause luminance non-uniformity since the amounts of coupling differ depending on the pixel positions in the direction in which the scan line 31 extends.

Although the failure caused by the wiring resistance and the wiring capacitance of the scan line 31 has been described above in conjunction with an example of the one-side driving system in which the write scan circuit 40 disposed at one side in the direction in which the rows of the pixels 20 are arranged drives the write transistors 23 in the pixels 20, the same can also be said of the case of the two-opposite-side driving system.

In the present embodiment, in order to reduce or eliminate the above-described failure caused by the capacitive coupling due to the parasitic capacitances of the write transistors 23, the parasitic capacitances between the gates and the sources of the write transistors 23 are varied in accordance with the pixel positions relative to the write scan circuit 40 in the direction in which the scan line 31 extends. More specifically, the parasitic capacitances between the gates and the sources of the write transistors 23 are set so that the amounts of change in the source potentials of the write transistors 23 during transition (i.e., falling) of the write scan signals WS become constant regardless of the wiring distances from the write scan circuit 40. The pixel position relative to the write scan circuit 40 also corresponds to the wiring distance on the scan line 31 from the write scan circuit 40.

Varying the parasitic capacitances between the gates and the sources of the write transistors 23 in accordance with the wiring distances from the write scan circuit 40, as described above, makes it possible to substantially equalize the amounts of coupling regardless of the pixel positions relative to the write scan circuit 40 in the direction in which the scan line 31 extends. With this arrangement, constant driving of the write transistors 23 in the pixels 20 with the write scan signals WS output from the write scan circuit 40 can be achieved regardless of the pixel positions relative to the write scan circuit 40 in the direction in which the scan line 31 extends. As a result, it is possible to reduce luminance non-uniformity caused by a difference in the amounts of coupling due to the capacitive coupling of the parasitic capacitances of the write transistors 23.

In the present embodiment, for example, a scheme for varying the gate-source overlap areas in accordance with the wiring distances may be used as the scheme for varying the parasitic capacitances between the gates and the sources of the write transistors 23 in accordance with the wiring distances from the write scan circuit 40.

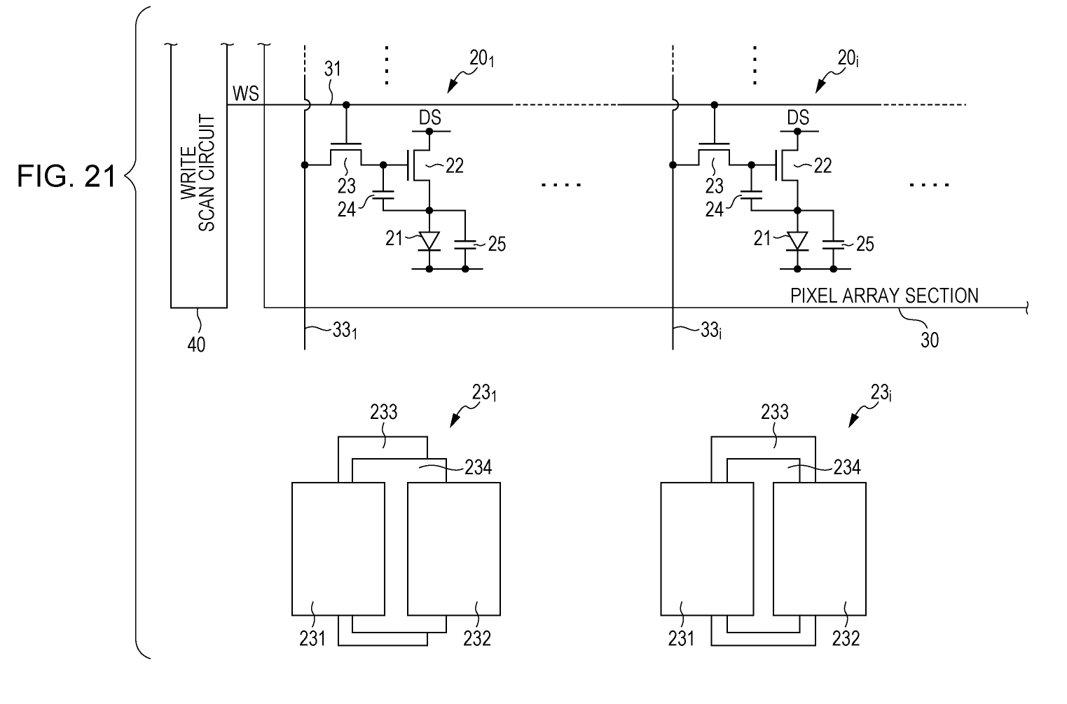

More specifically, in an example of FIG. 21, the gate-source overlap area of the write transistor 23₁ in the pixel 20₁ located at the closest position to the write scan circuit 40 is minimized. A reduction in the gate-source overlap area provides a relatively small parasitic capacitance. The gate-source overlap area of the write transistor 23ᵢ in the pixel 20ᵢ located at the farther position from the write scan circuit 40 than the pixel 20₁ is set larger than the gate-source overlap area of the write transistor 23₁. An increase in the gate-source overlap area provides a relatively large parasitic capacitance.

For changing the gate-source overlap areas, for example, a scheme for varying the size of a gate electrode 233 with the sizes of a source region 231 and a drain region 232 being fixed in FIG. 21 may be employed. More specifically, the scheme may be realized by varying the width of the gate electrode 233 in the channel length direction (the left-and-right direction in FIG. 21) with the widths of the source region 231 and the drain region 232 in the channel length direction being fixed in the channel length direction. FIG. 21 shows that the width of the gate electrode 233 of the write transistor 23₁ in the pixel 20₁ located at the closest position to the write scan circuit 40 is small compared to the width of the gate electrode 233 in the pixel 20ᵢ located at the farther position from the write scan circuit 40 than the pixel 20₁.

In the present embodiment, although the scheme for varying the gate-source overlap areas in accordance with the wiring distances has been employed as the scheme for varying the parasitic capacitances between the gates and the sources of the write transistors 23 in accordance with the wiring distances from the write scan circuit 40, this is merely one example. Another possible scheme is a scheme for varying the thicknesses, dielectric constants, or the like of insulating films 234 (which are dielectrics) interposed between the source regions 231/the drain regions 232 and the gate electrodes 233 in FIG. 21 in accordance with the wiring distance.

### 3. Application Examples

Although the example in which the present disclosure is applied to the pixel circuit having two pixel transistors, i.e., the drive transistor 22 and the write transistor 23, has been described in the above embodiments, the application of the present disclosure is not limited to the pixel circuit. For example, the present disclosure is applicable to a pixel circuit having a transistor connected in series with the drive transistor 22 to control light emission/non-emission of the organic EL element 21, a pixel circuit having a transistor for selectively applying the reference voltage V_{ofs} to the gate of the drive transistor 22, and so on.

For a display device in which such pixel circuits are arranged, since a driver disposed at one side of the panel or drivers disposed at two opposite sides thereof drive(s) those transistors, a failure caused by coupling due to the parasitic capacitance may occur. Thus, as in the case of the second embodiment, varying the parasitic capacitances between the gates and the sources in accordance with the wiring distances from the driver(s) makes it possible to reduce or eliminate the failure caused by the parasitic coupling.

Although an example in which the present disclosure is applied to an organic EL display device has been described in the above embodiments, the application of the present disclosure is not limited thereto. More specifically, the present disclosure is applicable to display devices using current-driven electro-optical elements (light-emitting elements) having emission luminances that vary according to the values of currents flowing in devices, such as organic EL elements, LED elements, and semiconductor laser elements.

In addition, the present disclosure is applicable not only to display devices using current-driven electro-optical elements, but also to display devices having a configuration in which transistors arranged along the direction in which a control line extends are driven with a drive signal output from a driver disposed at one side of a panel or drivers disposed at two opposite sides thereof and transmitted through the control line. Examples of such display devices include liquid crystal display devices and plasma display devices.

### 4. Electronic Apparatuses

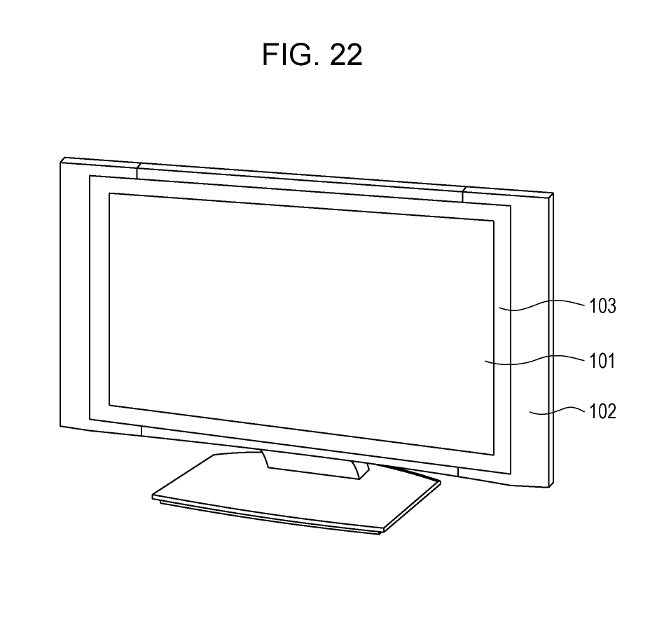

The above-described display device according to the embodiment of the present disclosure is applicable to display units (display devices) for electronic apparatuses in any fields in which video signals input to the electronic apparatuses or video signals generated thereby are displayed in the form of images or video. For example, the present disclosure is applicable to display units for various types of electronic apparatus, such as a television set, a digital camera, a video camera, a notebook personal computer, and a mobile terminal device such as a mobile phone, as illustrated in FIGS. 22 to 26G.

As is apparent from the description of the above-described embodiments, the display device according to the embodiment of the present disclosure can reduce luminance non-uniformity caused by coupling due to the parasitic capacitances of transistors arranged in a direction in which a control line extends. Accordingly, the use of the display device according to the embodiment of the present disclosure as a display unit for an electronic apparatus in an arbitrary field makes it possible to provide a high-quality display image.

The display device according to an embodiment of the present disclosure may also be implemented by a modular form having a sealed structure. The modular form corresponds to, for example, the display module formed by laminating the opposing portions, made of the transparent glass or the like, to the pixel array section. The display module may also be provided with, for example, an FPC (flexible printed circuit) or a circuit section for externally inputting/outputting a signal and so on to/from the pixel array section.

Specific examples of an electronic apparatus to which an embodiment of the present disclosure is applied will be described below.

FIG. 22 is a perspective view illustrating the external appearance of a television set to which an embodiment of the present disclosure is applied. The television set according to the application example includes a video display screen section 101 having a front panel 102, a filter glass 103, and so on. The television set is manufactured by using the display device according to the embodiment of the present disclosure as the video display screen section 101.

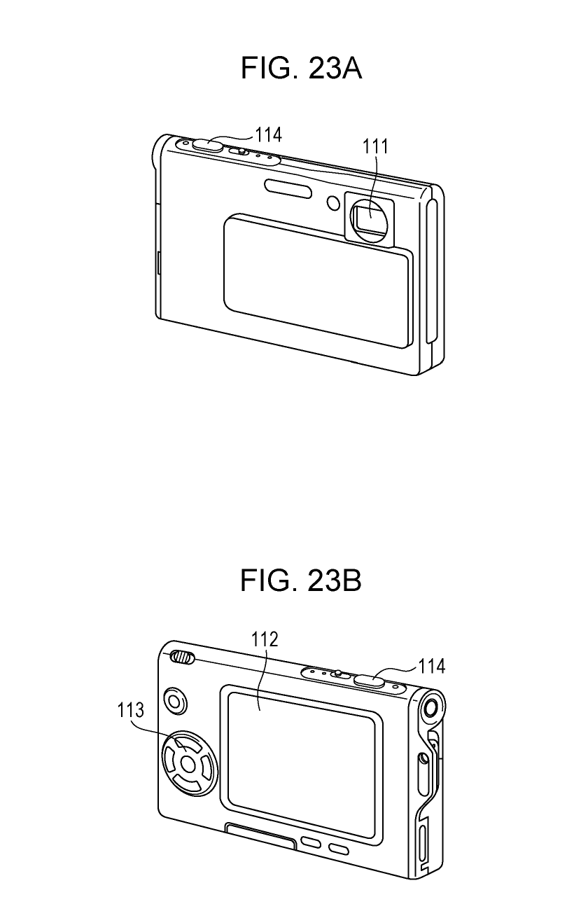

FIGS. 23A and 23B are a front perspective view and a rear perspective view, respectively, illustrating the external appearance of a digital camera to which an embodiment of the present disclosure is applied. The digital camera according to the application example includes a flashlight emitting section 111, a display section 112, a menu switch 113, a shutter button 114, and so on. The digital camera is manufactured using the display device according to the embodiment of the present disclosure as the display section 112.

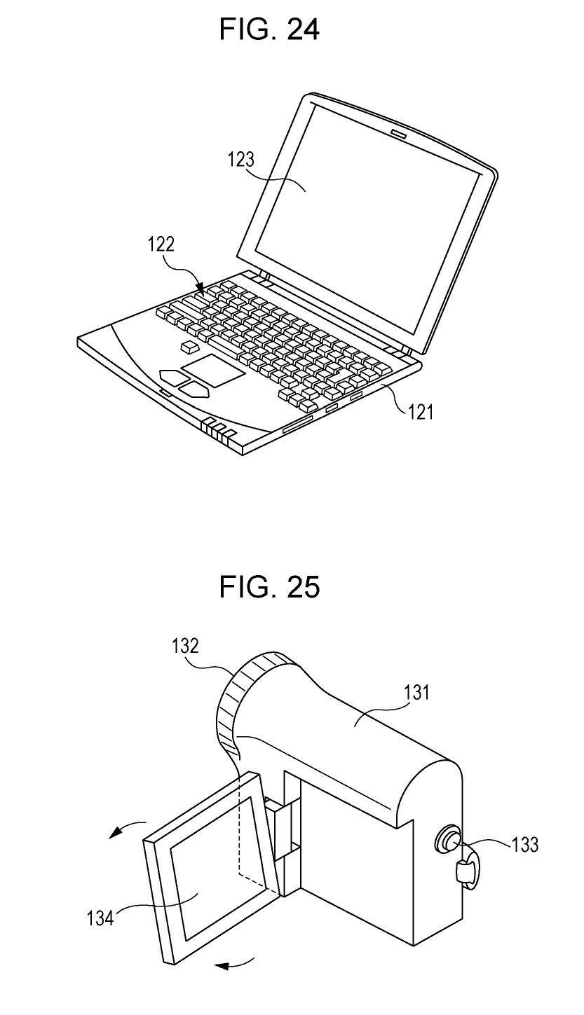

FIG. 24 is a perspective view illustrating the external appearance of a notebook personal computer to which an embodiment of the present disclosure is applied. The notebook personal computer according to the present application example has a configuration in which a main unit 121 includes a keyboard 122 for operation for inputting characters and so on, a display section 123 for displaying an image, and so on. The notebook personal computer is manufactured using the display device according to an embodiment of the present disclosure as the display section 123.

FIG. 25 is a perspective view illustrating the external appearance of a video camera to which an embodiment of the present disclosure is applied. The video camera according to the present application example includes a main unit 131, a subject-shooting lens 132 provided at a front side surface thereof, a start/stop switch 133 for shooting, a display section 134, and so on. The video camera is manufactured using the display device according to an embodiment of the present disclosure as the display section 134.

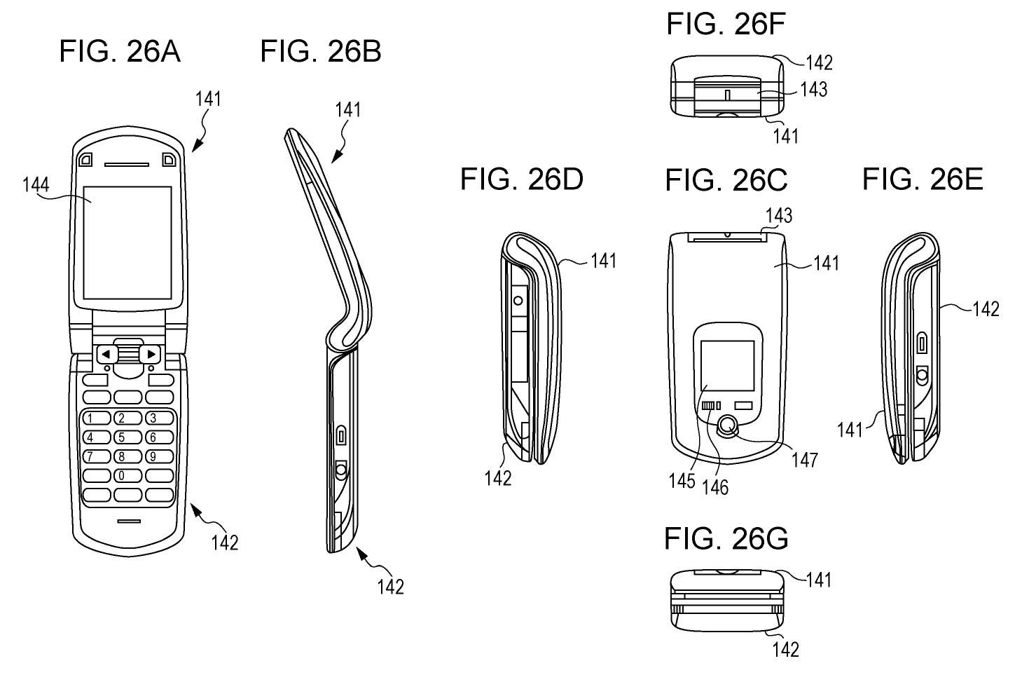

FIGS. 26A to 26G are external views of a mobile terminal device, for example, a mobile phone, to which an embodiment of the present disclosure is applied. Specifically, FIG. 26A is a front view of the mobile phone when it is opened, FIG. 26B is a side view thereof, FIG. 26C is a front view when the mobile phone is closed, FIG. 26D is a left side view, FIG. 26E is a right side view, FIG. 26F is a top view, and FIG. 26G is a bottom view. The mobile phone according to the present application example includes an upper casing 141, a lower casing 142, a coupling portion (a hinge portion, in this case) 143, a display 144, a sub display 145, a picture light 146, a camera 147, and so on. The mobile phone according to the present application example is manufactured using the display device according to the present application example as the display 144 and/or the sub display 145.

### 5. Configuration of Present Disclosure

(1) A display device including:

a control line through which a drive signal output from a driver is transmitted; and

transistors arranged along a direction in which the control line extends and driven with the drive signal transmitted through the control line,

wherein parasitic capacitances between gates and sources/drains of the transistors are varied in accordance with distances thereof from the driver in the direction in which the control line extends.

(2) The display device according to (1), wherein the parasitic capacitances between the gates and the sources/drains of the transistors are set so that amounts of change in voltages at the sources/drains during transition of the drive signal become constant regardless of positions of the transistors in the direction in which the control line extends.

(3) The display device according to (1) or (2), wherein areas in which gate electrodes and source/drain regions of the transistors overlap each other differ in accordance with the distances of the transistors from the driver in the direction in which the control line extends.

(4) The display device according to (3), wherein the gate electrodes of the transistors have sizes that differ in accordance with the distances of the transistors from the driver in the direction in which the control line extends.

(5) The display device according to (4), wherein the gate electrodes of the transistors have widths that differ in a channel direction in accordance with the distances of the transistors from the driver in the direction in which the control line extends.

(6) The display device according to one of (1) to (5), wherein the transistors are selection transistors that selectively supply signals to signal lines wired in corresponding pixel columns in a pixel array section in which pixels are arranged in a matrix.

(7) The display device according to (6), wherein the selection transistors distribute a time-sequentially input signal to the signal lines in a time-divided manner.

(8) The display device according to one of (1) to (5), wherein the transistors are write transistors provided in pixels to write signals to the pixels.

(9) The display device according to (8), wherein each pixel includes:

the write transistor;

a storage capacitor that stores the signal written by the write transistor; and

an electro-optical element driven according to the signal stored by the storage capacitor.

(10) The display device according to one of (1) to (9), wherein the driver drives the transistors from one side in a direction in which the transistors are arranged.

(11) The display device according to one of (1) to (9), wherein the driver drives the transistors from two opposite sides in a direction in which the transistors are arranged.

(12) An electronic apparatus having a display device including:

a control line through which a drive signal output from a driver is transmitted; and

transistors arranged along a direction in which the control line extends and driven with the drive signal transmitted through the control line,

wherein parasitic capacitances between gates and sources/drains of the transistors are varied in accordance with distances thereof from the driver in the direction in which the control line extends.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device comprising:
a control line through which a drive signal output from a driver is transmitted; and
transistors arranged along a direction in which the control line extends and driven with the drive signal transmitted through the control line,
wherein parasitic capacitances between gates and sources/drains of the transistors are varied in accordance with distances thereof from the driver in the direction in which the control line extends.

2. The display device according to claim 1, wherein the parasitic capacitances between the gates and the sources/drains of the transistors are set so that amounts of change in voltages at the sources/drains during transition of the drive signal become constant regardless of positions of the transistors in the direction in which the control line extends.

3. The display device according to claim 1, wherein areas in which gate electrodes and source/drain regions of the transistors overlap each other differ in accordance with the distances of the transistors from the driver in the direction in which the control line extends.

4. The display device according to claim 3, wherein the gate electrodes of the transistors have sizes that differ in accordance with the distances of the transistors from the driver in the direction in which the control line extends.

5. The display device according to claim 4, wherein the gate electrodes of the transistors have widths that differ in a channel direction in accordance with the distances of the transistors from the driver in the direction in which the control line extends.

6. The display device according to claim 1, wherein the transistors comprise selection transistors that selectively supply signals to signal lines wired in corresponding pixel columns in a pixel array section in which pixels are arranged in a matrix.

7. The display device according to claim 6, wherein the selection transistors distribute a time-sequentially input signal to the signal lines in a time-divided manner.

8. The display device according to claim 1, wherein the transistors comprise write transistors provided in pixels to write signals to the pixels.

9. The display device according to claim 8, wherein each pixel includes:
the write transistor;
a storage capacitor that stores the signal written by the write transistor; and
an electro-optical element driven according to the signal stored by the storage capacitor.

10. The display device according to claim 1, wherein the driver drives the transistors from one side in a direction in which the transistors are arranged.

11. The display device according to claim 1, wherein the driver drives the transistors from two opposite sides in a direction in which the transistors are arranged.

12. An electronic apparatus having a display device comprising:
a control line through which a drive signal output from a driver is transmitted; and
transistors arranged along a direction in which the control line extends and driven with the drive signal transmitted through the control line,
wherein parasitic capacitances between gates and sources/drains of the transistors are varied in accordance with distances thereof from the driver in the direction in which the control line extends.
